(19) United States
(12) Patent Application Publication
(10) Pub. No.: US 2008/0214386 A1
(43) Pub. Date: Sep. 4, 2008

(54) Catalyst for Cyclic Carbonate Synthesis

(76) Inventors: Toshikazu Takahashi, Ibaraki (JP); Tsutomu Watahiki, Ibaraki (JP); Hiroyuki Yasuda, Ibaraki (JP); Toshiyasu Sakakura, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 11/597,932

(22) PCT Filed: Mar. 1, 2005
(86) PCT No.: PCT/JP2005/003388

§ 371 Date: Dec. 13, 2007

(30) Foreign Application Priority Data
Mar. 4, 2004 (JP) 2004-055945
Mar. 4, 2004 (JP) 2004-059944

(51) Int. Cl. B01J 31/00

(52) U.S. Cl. 502/162; 502/100; 502/171

(57) ABSTRACT

Provided are a solid catalyst which gives a cyclic carbonate at a high yield and a high selectivity, which is stable and which may be readily separated after reaction; and a method of industrially advantageous, inexpensive and safe production of a cyclic carbonate by the use of the catalyst. The catalyst contains an inorganic solid substance having a surface modified with an ionic substance containing a Group 15 element; or contains an ionic substance containing a Group 15 element, and an inorganic solid substance. The modifying group for surface modification of an inorganic solid substance is an ionic substance containing a Group 15 element. The ionic substance containing a Group 15 element is at least one substance selected from organic phosphonium salts, organic ammonium salts, organic arsonium salts and organic antimonium salts.

### TECHNICAL FIELD

The present invention relates to a catalyst for use in producing a cyclic carbonate from an epoxide and carbon dioxide, and to a method for producing a cyclic carbonate by the use of the catalyst.

### BACKGROUND ART

A cyclic carbonate is one of important compounds to be used for many applications for organic solvents, synthetic fiber-processing agents, materials for medicines, additives to cosmetics, electrolyte solvents for lithium cells, and as intermediates in producing alkylene glycols and dialkyl carbonates.

Heretofore, such a cyclic carbonate is produced by reacting an epoxide and carbon dioxide in the presence of a homogeneous catalyst under suitable pressure. As the homogeneous catalyst, alkali metal halides (Patent Reference 1) and onium salts (Patent Reference 2) such as quaternary ammonium salts are well known for a long time and are used industrially.

Recently proposed is a method for producing a cyclic carbonate by the use of super-critical carbon dioxide not only as a reagent but also as a reaction medium in the presence of an alkali metal halide or a fluoroalkylphosphonium salt which the present inventors have found out (Patent Reference 3).

Further recently, it is reported that an ionic fluid such as octylmethylimidazolium tetrafluoroborate exhibits a good catalytic performance (Non-Patent Reference 1).

However, when a homogeneous catalyst is used, then it generally requires separation of the catalyst from the reaction mixture through distillation or the like, therefore resulting in that not only the production process is complicated but also there may occur some problems of degradation of catalyst or production of side products during the separation step.

On the other hand, proposed is use of a solid catalyst for the purpose of simplifying the catalyst separation process; and ion-exchange resins (Patent Reference 4), basic layered compounds such as hydrotalcite (Patent Reference 5), rare earth compounds (Patent Reference 6), heteropoly acids consisting essentially of tungsten oxide or molybdenum oxide (Patent Reference 7) are disclosed. Also reported is a possibility of using magnesia as a solid catalyst (Non-Patent Reference 2).

However, many solid catalysts are generally not satisfactory in point of the activity, the yield and the selectivity, as compared with homogeneous catalysts; and ion-exchange resins could not show an activity exceeding over the performance of molecular catalysts. Much time and energy are needed for preparing catalysts of high activity.

Patent Reference 1: JP-B 63-17072

Patent Reference 2: JP-A 55-145623

Patent Reference 3: JP-A 11-335372

Patent Reference 4: JP-A 3-120270

Patent Reference 5: JP-A 11-226413

Patent Reference 6: JP-A 2002-363177

Patent Reference 7: JP-A 7-206847

Non-Patent Reference 1: Chem. Commun., 2003, 896

Non-Patent Reference 2: Chem. Commun., 1997, 1129

### DISCLOSURE OF THE INVENTION

### Problems that the Invention is to Solve

The invention is to overcome the problems in conventional cyclic polycarbonate production as above, and its object is to provide a solid catalyst which may give a cyclic carbonate at a higher yield and a higher selectivity, which is stable and which may be readily separated after reaction, and to provide a method of industrially advantageous, inexpensive and safe production of a cyclic carbonate by the use of the catalyst.

### Means for Solving the Problems

The present inventors have assiduously studied for the purpose of solving the conventional problems mentioned above and, as a result, have found that a catalyst which contains an inorganic solid substance having a surface modified with an ionic substance that contains a Group 15 element has high activity and high selectivity in production of a cyclic carbonate through reaction of an epoxide and carbon dioxide, and have completed the invention.

Specifically, this application provides the following invention.

(1) A catalyst for use in producing a cyclic carbonate from an epoxide and carbon dioxide, which comprises an inorganic solid substance having a surface modified with an ionic substance containing a Group 15 element.

(2) The catalyst according to (1), wherein the ionic substance containing a Group 15 element is at least one substance selected from an organic phosphonium salt, an organic ammonium salt, an organic arsonium salt and an organic antimonium salt.

(3) The catalyst according to (2), wherein the salt selected from the organic phosphonium salt, organic ammonium salt, organic arsonium salt and organic antimonium salt is a halide.

(4) The catalyst according to (3), wherein an anion of the salt selected from the organic phosphonium salt, organic ammonium salt, organic arsonium salt and organic antimonium salt is at least one member selected from a sulfate ion, a hydrogensulfate ion, a phosphate ion, a hydrogenphosphate ion, a dihydrogenphosphate ion, a cyanide ion, an isothiocyanide ion, an isocyanate ion, a carbonate ion and a hydrogencarbonate ion.

(5) The catalyst according to any one of (1) to (4), wherein the inorganic solid substance is a metal oxide.

(6) The catalyst according to (5), wherein the metal oxide is a silicon-containing oxide.

(7) A catalyst for use in producing a cyclic carbonate from an epoxide and carbon dioxide, which comprises an ionic substance containing a Group 15 element, and an inorganic solid substance.

(8) The catalyst according to (7), wherein the ionic substance containing a Group 15 element is at least one substance selected from an organic phosphonium salt, an organic ammonium salt, an organic arsonium salt and an organic antimonium salt.

(9) The catalyst according to (8), wherein the salt selected from the organic phosphonium salt, organic ammonium salt, organic arsonium salt and organic antimonium salt is a halide.

(10) The catalyst according to (9), wherein an anion of the salt selected from the organic phosphonium salt, organic ammonium salt, organic arsonium salt and organic antimonium salt is at least one member selected from a sulfate ion, a hydrogensulfate ion, a phosphate ion, a hydrogenphosphate ion, a dihydrogenphosphate ion, a cyanide ion, an isothiocyanide ion, an isocyanate ion, a carbonate ion and a hydrogencarbonate ion.

(11) The catalyst according to any of (7) to (10), wherein the inorganic solid substance is a metal oxide.

(12) The catalyst according to (11), wherein the metal oxide is a silicon-containing oxide.

### EFFECT OF THE INVENTION

According to the catalyst of the invention, a cyclic carbonate, which is useful for electrolyte solvents for lithium cells, organic solvents, synthetic fiber-processing agents, materials for medicines, and as intermediates in producing alkylene glycols and dialkyl carbonates, can be obtained from an epoxide and carbon dioxide at extremely high yield and high selectivity. This can be used in a flow reaction system, and is safe and inexpensive and has a long life, and it can be readily separated and recovered.

### BRIEF DESCRIPTION OF THE DRAWING

FIG. 1 is an explanatory view of a flow reaction system favorably used in the invention.

### BEST MODE FOR CARRYING OUT THE INVENTION

The reaction for synthesis of a cyclic carbonate from an epoxide and carbon dioxide in the invention may be represented by the following general formula (1):

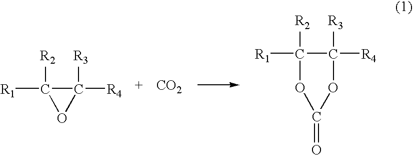

In the above general formula (1), R₁, R₂, R₃ and R₄ each represent a hydrogen atom, or a substituent-having or unsubstituted organic group, more precisely, an alkyl group, an aryl group, an alkenyl group, a cycloalkyl group, and an arylalkyl group; and they may be the same or different. Examples of the substituent as referred to herein include a halogen atom, a halogenalkyl group, a dialkylamino group, a nitro group, a carbonyl group, a carboxyl group, an alkoxy group, an acetoxy group, a cyano group, a hydroxyl group, a mercapto group, and a sulfone group, to which, however, the substituent should not be limited. Any or more of R₁ to R₄ may bond to each other to form a cyclic structure, and may contain an unsaturated bond.

The epoxide for use in the invention is a compound of the following general formula (2):

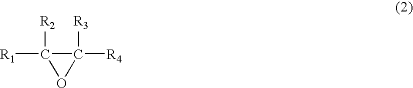

In the above general formula (2), R₁, R₂, R₃ and R₄ have the same meanings as in the above general formula (1). Any or more of R₁ to R₄ may bond to each other to form a cyclic structure, and may contain a hetero element and an unsaturated bond. Concretely, examples of the compound include ethylene oxide, propylene oxide, butylene oxide, isobutylene oxide, vinylethylene oxide, trifluoromethylethylene oxide, cyclohexene oxide, styrene oxide, butadiene monoxide, butadiene dioxide, chloral, 2-methyl-3-phenylbutane oxide, pinene oxide, and tetracyanoethylene oxide. Not limited to these, however, the epoxide in the invention may be any and every epoxy compound that contains at least one 3-membered ring structure composed of two carbon atoms and one oxygen atom.

The cyclic carbonate to be produced in the invention is a compound of the following general formula (3):

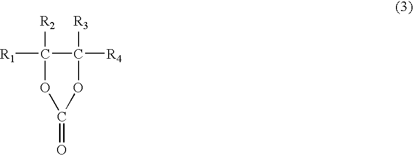

In the above general formula (3), R₁, R₂, R₃ and R₄ have the same meanings as in the above general formula (1). Any or more of R₁ to R₄ may bond to each other to form a cyclic structure, and may contain a hetero element and an unsaturated bond. Concretely, examples of the compound include ethylene carbonate, propylene carbonate, butylene carbonate, isobutylene carbonate, trifluoromethylethylene carbonate, vinylethylene carbonate, cyclohexene carbonate, styrene carbonate, butadiene monocarbonate, butadiene dicarbonate, chloromethyl carbonate, pinene carbonate, and tetracyanoethylene carbonate. Not limited to these, however, the cyclic carbonate to be produced in the invention may be any and every cyclic carbonate that contains a 5-membered ring having an O—CO—O bond.

The catalyst of the first embodiment for use in the invention contains an inorganic solid substance having a surface modified with a Group 15 element-containing ionic substance. In the surface-modified inorganic solid substance, in general, the Group 15 element-containing ionic substance bonds to the inorganic solid substance via a chemical bond therebetween.

The Group 15 element-containing ionic substance means at least one substance selected from organic phosphonium salts, organic ammonium salts, organic arsonium salts and organic antimonium salts. Preferred for use in the invention are organic phosphonium salts, organic arsonium salts and organic antimonium salts.

In general, these Group 15 element-containing ionic substances may be represented by a general formula ER₅R₆R₇R₈X.

Herein, E represents one of Group 15 elements (nitrogen, phosphorus, arsenic, antimony, bismuth). R₅ to R₈ each represent an optionally-substituted organic group, more precisely an alkyl group or an aryl group; and 2 to 4 of these may bond to each other to form a cyclic structure. In this case, the ring may have a double bond or a triple bond. Accordingly, the compound includes nitrogen-containing heterocyclic salts such as imidazolium, pyridinium, and tetrazolium salts.

X represents an anion. It is one or more anions selected from halide ion, phosphate ion, hydrogenphosphate ion, dihydrogenphosphate ion, nitrate ion, sulfate ion, hydrogensulfate ion, organic acid ion, carbonate ion, hydrogencarbonate ion, borate ion, hydrogenborate ion, hydrogenborate ion, alkyl or arylsulfate ion, mono or dialkylphosphate ion, mono or diarylphosphate ion, mono or dialkylborate ion, cyanide ion, thiocyanate ion, isocyanate ion, carbonate ion, tetrafluoroborate ion and the like. Preferred are halide ion, sulfate ion, hydrogensulfate ion, phosphate ion, hydrogenphosphate ion, dihydrogenphosphate ion, cyanide ion, isothiocyanide ion, isocyanate ion, carbonate ion and hydrogencarbonate ion; and more preferred is halide ion such as chloride ion, bromide ion, and iodide ion.

The inorganic solid substance to be used in the invention may be any and every simple substance or compound that is a solid-stage inorganic substance. Concretely, examples thereof includes simple substances such as carbon, silicon, aluminium, titanium, iron, copper, silver, gold, platinum, nickel, cobalt, and titanium; alloys of two or more metals; metal oxides, metal nitrides, metal carbides, metal sulfides, metal halides, metal borides, metal phosphorides, metal oxyhalides, metal oxynitrides and metal oxysulfides containing one or more metals; and their mixtures. Preferred for use herein are oxides of elements of Groups 2 to 6, Group 13 and Group 14; and more preferred are silicon-containing oxides (e.g., silica).

In general, those having a surface area of from 10 m²/g to 2000 m²/g or so are preferred for use herein.

Of the silicon-containing oxides preferred for use in the invention, the most easily available one is silica gel for separation and silica gel for drying.

Not specifically defined in point of its shape, the inorganic solid substance for use in the invention may be generally fine powdery, thin filmy, or spherical or columnar particles having a mean particle size of about from 0.1 to 10 mm.

The surface-modified inorganic solid substance catalyst for use in the invention is represented by a schematic formula S-ER₅R₆R₇R₈X, and is represented by a chemical formula 4 mentioned below. In this regard, S represents a solid substance mentioned in the previous section. E represents any one of Group 15 elements. R₅ to R₈ each represents an organic group as in the previous section, which may be the same or different and are any of optionally-substituted alkyl, aryl and aralkyl groups; and any of them or all of them may bond to each other to form a cyclic structure, and may contain a hetero atom. In fact, one or more substituents of R chemically bond to the solid S. For example, one embodiment where R₅ alone chemically bonds to the solid surface is shown in a chemical formula 5. In the embodiment of the chemical formula 5, the R₅ moiety is herein referred to as a linker. Candidates for the linker include those comprising a carbon skeleton such as an alkylene group, an arylene group or an aralkylene group of which the terminal bonds directly to the solid substance, and those comprising a covalent bond with a skeleton hetero atom such as a polyethylene glycol chain or a silicone chain, which may be branched or may have a ring, or may have a substituent containing an unsaturated bond or a hetero element with no problem. More concretely, herein employable are those having a methylene group, an ethylene group, a propylene group, a butylene group, a pentylene group, a hexylene group, a heptylene group, an octylene group, a phenylene group, a phenylmethylene group, a xylyl group, an alkylenephenylene group, a phenylenealkylene group, or a polyethylene glycolyl group; and preferred are those having a trimethylene group. Similarly in case where one linker moiety is present, three organic groups constituting the remaining ER₆R₇R₈ in the onium moiety may be any combination selected from an alkyl group, an aryl group, an aralkyl group, an oxyalkyl group, and an oxyaryl group, more concretely, a methyl group, an ethyl group, a propyl group, a butyl group, a pentyl group, a cyclopentadienyl group, a ferrocenyl group, a hexyl group, a cyclohexyl group, a phenyl group, a pentyl group, a tolyl group a methoxyphenyl group, a benzyl group, an octyl group, and a naphthyl group. For more concretely expressing the solid, the linker and the onium salt, for example, a schematic view of the following chemical formula 6 may be employed.

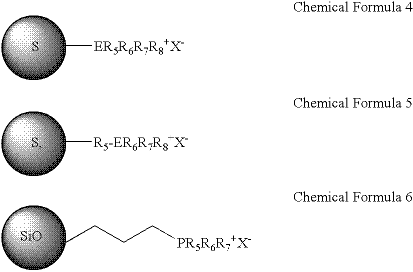

In the above formulae, SiO₂ means a silica gel; L means a linker, generally representing an alkylene group having from 2 to 8 carbon atoms, preferably an alkylene group having 3 carbon atoms. R means a substituent on the phosphorus atom, representing an alkyl group or an aryl group. R₅ to R₈ are the same as those mentioned in the above; and X means the above-mentioned anion.

Not specifically defined in point of its production method, the surface-modified silica catalyst for use in the invention may be produced, for example, through reaction of a commercially-available, haloalkyl group or haloaryl group-modified silica gel with a Group 15 element-containing substance. In the surface-modified silica thus produced, the counter ion, anion may be changed to any others through ion-exchange reaction.

It is not always necessary to separately produce the surface-modified silica catalyst. In the reaction system of producing a cyclic carbonate from an epoxide and carbon dioxide, a haloalkyl group or haloaryl group-modified silica gel and a Group 15 element-containing substance may be made to exist along with the reactants, whereby the same effect as that of the surface-modified silica catalyst may be attained.

In the invention, the surface-modified silica may be held by any desired carrier. Examples of the carrier include silica, alumina, zeolite, silicon carbide, clay minerals (e.g., montmorillonite), silica-alumina, zirconia, titania, zinc oxide, cadmium sulfide, and magnesia, to which, however, the invention should not be limited.

The catalyst of the second embodiment for use in the invention has a characteristic of containing a Group 15 element-containing ionic substance (hereinafter this may be referred to as an onium salt) and an inorganic solid substance.

The Group 15 element-containing ionic substance may be at least one substance selected from organic phosphonium salts, organic arsonium salts, organic antimonium salts and organic ammonium salts as in the first embodiment mentioned hereinabove.

Specific examples of the Group 15 element-containing ionic substance include tetramethylphosphonium iodide, tetramethylphosphonium bromide, tetramethylphosphonium chloride, tetraethylphosphonium iodide, tetraethylphosphonium bromide, tetraethylphosphonium chloride, tetrapropylphosphonium iodide, tetrapropylphosphonium bromide, tetrapropylphosphonium chloride, tetrabutylphosphonium iodide, tetrabutylphosphonium bromide, tetrabutylphosphonium chloride, terapentylphosphonium iodide, terapentylphosphonium bromide, terapentylphosphonium chloride, tetrahexylphosphonium iodide, tetrahexylphosphonium bromide, tetrahexylphosphonium chloride, tetraphenylphosphonium iodide, tetraphenylphosphonium bromide, tetraphenylphosphonium chloride, tetraheptylphosphonium iodide, tetraheptylphosphonium bromide, tetraheptylphosphonium chloride, tetrabenzylphosphonium iodide, tetrabenzylphosphonium bromide, tetrabenzylphosphonium chloride, tetraoctylphosphonium iodide, tetraoctylphosphonium bromide, tetraoctylphosphonium chloride, tetranonylphosphonium iodide, tetranonylphosphonium bromide, tetranonylphosphonium chloride, tetrakisdecylphosphonium iodide, tetrakisdecylphosphonium bromide, tetrakisdecylphosphonium chloride, tetradodecylphosphonium iodide, tetradodecylphosphonium bromide, tetradodecylphosphonium chloride, tetrakistetradecylphosphonium iodide, tetrakistetradecylphosphonium bromide, tetrakistetradecylphosphonium chloride, tetrakishexadecylphosphonium iodide, tetrakishexadecylphosphonium bromide, tetrakishexadecylphosphonium iodide, tetrakisoctadecylphosphonium iodide, tetrakisoctadecylphosphonium bromide, tetrakisoctadecylphosphonium chloride, trimethylpropylphosphonium iodide, trimethylpropylphosphonium bromide, trimethylpropylphosphonium chloride, butyltrimethylphosphonium iodide, butyltrimethylphosphonium bromide, butyltrimethylphosphonium chloride, trimethylpentylphosphonium iodide, trimethylpentylphosphonium bromide, trimethylpentylphosphonium chloride, hexyltrimethylphosphonium iodide, hexyltrimethylphosphonium bromide, hexyltrimethylphosphonium chloride, heptyltrimethylphosphonium iodide, trimethylphenylphosphonium iodide, trimethylphenylphosphonium bromide, trimethylphenylphosphonium chloride, heptyltrimethylphosphonium bromide, heptyltrimethylphosphonium chloride, benzyltrimethylphosphonium iodide, benzyltrimethylphosphonium bromide, benzyltrimethylphosphonium chloride, trimethyloctylphosphonium iodide, trimethyloctylphosphonium bromide, trimethyloctylphosphonium chloride, trimethylnonylphosphonium iodide, trimethylnonylphosphonium bromide, trimethylnonylphosphonium chloride, decyltrimethylphosphonium iodide, decyltrimethylphosphonium bromide, decyltrimethylphosphonium chloride, trimethylundecylphosphonium iodide, trimethylundecylphosphonium bromide, trimethylundecylphosphonium chloride, dodecyltrimethylphosphonium iodide, dodecyltrimethylphosphonium bromide, dodecyltrimethylphosphonium chloride, trimethyltetradecylphosphonium iodide, trimethyltetradecylphosphonium bromide, trimethyltetradecylphosphonium chloride, hexadecyltrimethylphosphonium iodide, hexadecyltrimethylphosphonium bromide, hexadecyltrimethylphosphonium chloride, trimethylocatadecylphosphonium iodide, trimethylocatadecylphosphonium bromide, trimethylocatadecylphosphonium chloride, triethylmethylphosphonium iodide, triethylmethylphosphonium bromide, triethylmethylphosphonium chloride, triethylpropylphosphonium iodide, triethylpropylphosphonium bromide, triethylpropylphosphonium chloride, triethylbutylphosphonium iodide, triethylbutylphosphonium bromide, triethylbutylphosphonium chloride, triethylpentylphosphonium iodide, triethylpentylphosphonium bromide, triethylpentylphosphonium chloride, triethylhexylphosphonium iodide, triethylhexylphosphonium bromide, triethylhexylphosphonium chloride, triethylphenylphosphonium iodide, triethylphenylphosphonium bromide, triethylphenylphosphonium chloride, triethylheptylphosphonium iodide, triethylheptylphosphonium bromide, triethylheptylphosphonium chloride, benzyltriethylphosphonium iodide, benzyltriethylphosphonium bromide, benzyltriethylphosphonium chloride, triethyloctylphosphonium iodide, triethyloctylphosphonium bromide, triethyloctylphosphonium chloride, triethylnonylphosphonium iodide, triethylnonylphosphonium bromide, triethylnonylphosphonium chloride, triethyldecylphosphonium iodide, triethyldecylphosphonium bromide, triethyldecylphosphonium chloride, triethylundecylphosphonium iodide, triethylundecylphosphonium bromide, triethylundecylphosphonium chloride, triethyldodecylphosphonium iodide, triethyldodecylphosphonium bromide, triethyldodecylphosphonium chloride, triethyltetradecylphosphonium iodide, triethyltetradecylphosphonium bromide, triethyltetradecylphosphonium chloride, triethylhexadecylphosphonium iodide, triethylhexadecylphosphonium bromide, triethylhexadecylphosphonium chloride, triethyloctadecylphosphonium iodide, triethyloctadecylphosphonium bromide, triethyloctadecylphosphonium chloride, methyltripropylphosphonium iodide, methyltripropylphosphonium bromide, methyliripropylphosphonium chloride, ethyltripropylphosphonium iodide, ethyltripropylphosphonium bromide, ethyltripropylphosphonium chloride, butyltripropylphosphonium iodide, butyltripropylphosphonium bromide, butyltripropylphosphonium chloride, pentyltripropylphosphonium iodide, pentyltripropylphosphonium bromide, pentyltripropylphosphonium chloride, hexyltripropylphosphonium iodide, hexyltripropylphosphonium bromide, hexyltripropylphosphonium chloride, phenyltripropylphosphonium iodide, phenyltripropylphosphonium bromide, phenyltripropylphosphonium chloride, heptyltripropylphosphonium iodide, heptyltripropylphosphonium bromide, heptyltripropylphosphonium chloride, benzyltripropylphosphonium iodide, benzyltripropylphosphonium bromide, benzyltripropylphosphonium chloride, octyltripropylphosphonium iodide, octyltripropylphosphonium bromide, octyltripropylphosphonium chloride, nonyltripropylphosphonium iodide, nonyltripropylphosphonium bromide, nonyltripropylphosphonium chloride, decyltripropylphosphonium iodide, decyltripropylphosphonium bromide, decyltripropylphosphonium chloride, tripropylundecylphosphonium iodide, tripropylundecylphosphonium bromide, tripropylundecylphosphonium chloride, dodecyltripropylphosphonium iodide, dodecyltripropylphosphonium bromide, dodecyltripropylphosphonium chloride, tetradecyltripropylphosphonium iodide, tetradecyltripropylphosphonium bromide, tetradecyltripropylphosphonium chloride, hexadecyltripropylphosphonium iodide, hexadecyltripropylphosphonium bromide, hexadecyltripropylphosphonium chloride, octadecyltripropylphosphonium iodide, octadecyltripropylphosphonium bromide, octadecyltripropylphosphonium chloride, tributylmethylphosphonium iodide, tributylmethylphosphonium bromide, tributylmethylphosphonium chloride, tributylethylphosphonium iodide, tributylethylphosphonium bromide, tributylethylphosphonium chloride, tributylpropylphosphonium iodide, tributylpropylphosphonium bromide, tributylpropylphosphonium chloride, tributylpentylphosphonium iodide, tributylpentylphosphonium bromide, tributylpentylphosphonium chloride, tributylhexylphosphonium iodide, tributylhexylphosphonium bromide, tributylhexylphosphonium chloride, tributylphenylphosphonium iodide, tributylphenylphosphonium bromide, tributylphenylphosphonium chloride, tributylheptylphosphonium iodide, tributylheptylphosphonium bromide, tributylheptylphosphonium chloride, benzyltributylphosphonium iodide, benzyltributylphosphonium bromide, benzyltributylphosphonium chloride, tributyloctylphosphonium iodide, tributyloctylphosphonium bromide, tributyloctylphosphonium chloride, tributylnonylphosphonium iodide, tributylnonylphosphonium bromide, tributylnonylphosphonium chloride, tributyldecylphosphonium iodide, tributyldecylphosphonium bromide, tributyldecylphosphonium chloride, tributylundecylphosphonium iodide, tributylundecylphosphonium bromide, tributylundecylphosphonium chloride, tributyldodecylphosphonium iodide, tributyldodecylphosphonium bromide, tributyldodecylphosphonium chloride, tributyltetradecylphosphonium iodide, tributyltetradecylphosphonium bromide, tributyltetradecylphosphonium chloride, tributylhexadecylphosphonium iodide, tributylhexadecylphosphonium bromide, tributylhexadecylphosphonium chloride, tributylocatadecylphosphonium iodide, tributylocatadecylphosphonium bromide, tributylocatadecylphosphonium chloride, methyltripentylphosphonium iodide, methyltripentylphosphonium bromide, methyltripentylphosphonium chloride, ethyltripenthylphosphonium iodide, ethyltripenthylphosphonium bromide, ethyltripenthylphosphonium chloride, tripentylpropylphosphonium iodide, tripentylpropylphosphonium bromide, tripentylpropylphosphonium chloride, butyltripentylphosphonium iodide, butyltripentylphosphonium bromide, butyltripentylphosphonium chloride, hexyltripentylphosphonium iodide, hexyltripentylphosphonium bromide, hexyltripentylphosphonium chloride, tripentylphenylphosphonium iodide, tripentylphenylphosphonium bromide, tripentylphenylphosphonium chloride, heptyltripentylphosphonium iodide, heptyltripentylphosphonium bromide, heptyltripentylphosphonium chloride, benzyltripentylphosphonium iodide, benzyltripentylphosphonium bromide, benzyltripentylphosphonium chloride, octyltripentylphosphonium iodide, octyltripentylphosphonium bromide, octyltripentylphosphonium chloride, nonyltripentylphosphonium iodide, nonyltripentylphosphonium bromide, nonyltripentylphosphonium chloride, decyltripentylphosphonium iodide, decyltripentylphosphonium bromide, decyltripentylphosphonium chloride, tripentylundecylphosphonium iodide, tripentylundecylphosphonium bromide, tripentylundecylphosphonium chloride, dodecyltripentylphosphonium iodide, dodecyltripentylphosphonium bromide, dodecyltripentylphosphonium chloride, tetradecyltripentylphosphonium iodide, dodecyltripentylphosphonium bromide, dodecyltripentylphosphonium chloride, tripentyltetradecylphosphonium iodide, tripentyltetradecylphosphonium bromide, tripentyltetradecylphosphonium chloride, hexadecyltripentylphosphonium iodide, hexadecyltripentylphosphonium bromide, hexadecyltripentylphosphonium chloride, octadecyltripentylphosphonium iodide, octadecyltripentylphosphonium bromide, octadecyltripentylphosphonium chloride, trihexylmethylphosphonium iodide, trihexylmethylphosphonium bromide, trihexylmethylphosphonium chloride, ethyltrihexylphosphonium iodide, ethyltrihexylphosphonium bromide, ethyltrihexylphosphonium chloride, trihexylpropylphosphonium iodide, trihexylpropylphosphonium bromide, trihexylpropylphosphonium chloride, butyltrihexylphosphonium iodide, butyltrihexylphosphonium bromide, butyltrihexylphosphonium chloride, trihexylpentylphosphonium iodide, trihexylpentylphosphonium bromide, trihexylpentylphosphonium chloride, trihexylphenylphosphonium iodide, trihexylphenylphosphonium bromide, trihexylphenylphosphonium chloride, heptyltrihexylphosphonium iodide, heptyltrihexylphosphonium bromide, heptyltrihexylphosphonium chloride, benzyltrihexylphosphonium iodide, benzyltrihexylphosphonium bromide, benzyltrihexylphosphonium chloride, trihexyloctylphosphonium iodide, trihexyloctylphosphonium bromide, trihexyloctylphosphonium chloride, trihexylnonylphosphonium iodide, trihexylnonylphosphonium bromide, trihexylnonylphosphonium chloride, decyltrihexylphosphonium iodide, decyltrihexylphosphonium bromide, decyltrihexylphosphonium chloride, trihexylundecylphosphonium iodide, trihexylundecylphosphonium bromide, trihexylundecylphosphonium chloride, dodecyltrihexylphosphonium iodide, dodecyltrihexylphosphonium bromide, dodecyltrihexylphosphonium chloride, trihexyltetradecylphosphonium iodide, trihexyltetradecylphosphonium bromide, trihexyltetradecylphosphonium chloride, hexadecyltrihexylphosphonium iodide, hexadecyltrihexylphosphonium bromide, hexadecyltrihexylphosphonium chloride, trihexyloctadecylphosphonium iodide, trihexyloctadecylphosphonium bromide, trihexyloctadecylphosphonium chloride, methyltriphenylphosphonium iodide, methyltriphenyl phosphonium bromide, methyltriphenylphosphonium chloride, ethyltriphenylphosphonium iodide, ethyltriphenylphosphonium bromide, ethyltriphenylphosphonium chloride, triphenylpropylphosphonium iodide, triphenylpropylphosphonium bromide, triphenylpropylphosphonium chloride, butyltriphenylphosphonium iodide, butyltriphenylphosphonium bromide, butyltriphenylphosphonium chloride, hexyltriphenylphosphonium iodide, hexyltriphenylphosphonium bromide, hexyltriphenylphosphonium chloride, pentyltriphenylphosphonium iodide, pentyltriphenylphosphonium bromide, pentyltriphenylphosphonium chloride, hexyltriphenylphsophonium iodide, hexyltriphenylphsophonium bromide, hexyltriphenylphsophonium chloride, heptyltriphenylphosphonium iodide, heptyltriphenylphosphonium bromide, heptyltriphenylphosphonium chloride, benzyltriphenylphosphonium iodide, benzyltriphenylphosphonium bromide, benzyltriphenylphosphonium chloride, octyltriphenylphosphonium iodide, octyltriphenylphosphonium bromide, octyltriphenylphosphonium chloride, nonyltriphenylphosphonium iodide, nonyltriphenylphosphonium bromide, nonyltriphenylphosphonium chloride, decyltriphenylphosphonium iodide, decyltriphenylphosphonium bromide, decyltriphenylphosphonium chloride, triphenyldecylphosphonium iodide, triphenyldecylphosphonium bromide, triphenyldecylphosphonium chloride, dodecyltriphenylphosphonium iodide, dodecyltriphenylphosphonium bromide, dodecyltriphenylphosphonium chloride, tetradecyltriphenylphosphonium iodide, dodecyltriphenylphosphonium bromide, dodecyltriphenylphosphonium chloride, triphenyltetradecylphosphonium iodide, triphenyltetradecylphosphonium bromide, triphenyltetradecylphosphonium chloride, hexadecyltriphenylphosphonium iodide, hexadecyltriphenylphosphonium bromide, hexadecyltriphenylphosphonium chloride, octadecyltriphenylphosphonium iodide, octadecyltriphenylphosphonium bromide, octadecyltriphenylphosphonium chloride, triheptylmethylphosphonium iodide, triheptylmethylphosphonium bromide, triheptylmethylphosphonium chloride, ethyltriheptylphosphonium iodide, ethyltriheptylphosphonium bromide, ethyltriheptylphosphonium chloride, triheptylpropylphosphonium iodide, triheptylpropylphosphonium bromide, triheptylpropylphosphonium chloride, butyltriheptylphosphonium iodide, butyltriheptylphosphonium bromide, butyltriheptylphosphonium chloride, triheptylpentylphosphonium iodide, triheptylpentylphosphonium bromide, triheptylpentylphosphonium chloride, triheptylhexylphosphonium iodide, triheptylhexylphosphonium bromide, triheptylhexylphosphonium chloride, triheptyloctylphosphonium iodide, triheptyloctylphosphonium bromide, triheptyloctylphosphonium chloride, triheptylnonylphosphonium iodide, triheptylnonylphosphonium bromide, triheptylnonylphosphonium chloride, decyltriheptylphosphonium iodide, decyltriheptylphosphonium bromide, decyltriheptylphosphonium chloride, triheptylundecylphosphonium iodide, triheptylundecylphosphonium bromide, triheptylundecylphosphonium chloride, dodecyltriheptylphosphonium iodide, dodecyltriheptylphosphonium bromide, dodecyltriheptylphosphonium chloride, triheptyltetradecylphosphonium iodide, triheptyltetradecylphosphonium bromide, triheptyltetradecylphosphonium chloride, triheptylhexadecylphosphonium iodide, triheptylhexadecylphosphonium bromide, triheptylhexadecylphosphonium chloride, tribenzylmethylphosphonium iodide, tribenzylmethylphosphonium bromide, tribenzylmethylphosphonium chloride, tribenzylethylphosphonium iodide, tribenzylethylphosphonium bromide, tribenzylethylphosphonium chloride, tribenzylpropylphosphonium iodide, tribenzylpropylphosphonium bromide, tribenzylpropylphosphonium chloride, tribenzylbutylphosphonium iodide, tribenzylbutylphosphonium bromide, tribenzylbutylphosphonium chloride, tribenzylpentylphosphonium iodide, tribenzylpentylphosphonium bromide, tribenzylpentylphosphonium chloride, tribenzylhexylphosphonium iodide, tribenzylhexylphosphonium bromide, tribenzylhexylphosphonium chloride, tribenzylphenylphosphonium iodide, tribenzylphenylphosphonium bromide, tribenzylphenylphosphonium chloride, tribenzylheptylphosphonium iodide, tribenzylheptylphosphonium bromide, tribenzylheptylphosphonium chloride, tribenzyloctylphosphonium iodide, tribenzyloctylphosphonium bromide, tribenzyloctylphosphonium chloride, tribenzylnonylphosphonium iodide, tribenzylnonylphosphonium bromide, tribenzylnonylphosphonium chloride, tribenzyldecylphosphonium iodide, tribenzyldecylphosphonium bromide, tribenzyldecylphosphonium chloride, tribenzyldecylphosphonium iodide, tribenzyldecylphosphonium bromide, tribenzyldecylphosphonium chloride, tribenzyldecylphosphonium iodide, tribenzyldecylphosphonium bromide, tribenzyldecylphosphonium chloride, tribenzyltetradecylphosphonium iodide, tribenzyltetradecylphosphonium bromide, tribenzyltetradecylphosphonium chloride, tribenzylhexadecylphosphonium iodide, tribenzylhexadecylphosphonium bromide, tribenzylhexadecylphosphonium chloride, tribenzyloctadecylphosphonium iodide, tribenzyloctadecylphosphonium bromide, tribenzyloctadecylphosphonium chloride, methyltrioctylphosphonium iodide, methyltrioctylphosphonium bromide, methyltrioctylphosphonium chloride, ethyltrioctylphosphonium iodide, ethyltrioctylphosphonium bromide, ethyltrioctylphosphonium chloride, trioctylpropylphosphonium iodide, trioctylpropylphosphonium bromide, trioctylpropylphosphonium chloride, butyltrioctylphosphonium iodide, butyltrioctylphosphonium bromide, butyltrioctylphosphonium chloride, trioctylpentylphosphonium iodide, trioctylpentylphosphonium bromide, trioctylpentylphosphonium chloride, hexyltrioctylphosphonium iodide, hexyltrioctylphosphonium bromide, hexyltrioctylphosphonium chloride, heptyltrioctylphosphonium iodide, heptyltrioctylphosphonium bromide, heptyltrioctylphosphonium chloride, nonyltrioctylphosphonium iodide, nonyltrioctylphosphonium bromide, nonyltrioctylphosphonium chloride, decyltrioctylphosphonium iodide, decyltrioctylphosphonium bromide, decyltrioctylphosphonium chloride, trioctylundecylphosphonium iodide, trioctylundecylphosphonium bromide, trioctylundecylphosphonium chloride, dodecyltrioctylphosphonium iodide, dodecyltrioctylphosphonium bromide, dodecyltrioctylphosphonium chloride, trioctyltetradecylphosphonium iodide, trioctyltetradecylphosphonium bromide, trioctyltetradecylphosphonium chloride, hexadecyltrioctylphosphonium iodide, hexadecyltrioctylphosphonium bromide, hexadecyltrioctylphosphonium chloride, octadecyltrioctylphosphonium iodide, octadecyltrioctylphosphonium bromide, octadecyltrioctylphosphonium chloride, diethyldimethylphosphonium iodide, diethyldimethylphosphonium bromide, diethyldimethylphosphonium chloride, dimethyldipropylphosphonium iodide, dimethyldipropylphosphonium bromide, dimethyldipropylphosphonium chloride, dibutyldimethylphosphonium iodide, dibutyldimethylphosphonium bromide, dibutyldimethylphosphonium chloride, dimethylpentylphosphonium iodide, dimethylpentylphosphonium bromide, dimethylpentylphosphonium chloride, dihexyldimethylphosphonium iodide, dihexyldimethylphosphonium bromide, dihexyldimethylphosphonium chloride, dimethyldiphenylphosphonium iodide, dimethyldiphenylphosphonium bromide, dimethyldiphenylphosphonium chloride, diheptyldimethylphosphonium iodide, diheptyldimethylphosphonium bromide, diheptyldimethylphosphonium chloride, dibenzyldimethylphosphonium iodide, dibenzyldimethylphosphonium bromide, dibenzyldimethylphosphonium chloride, dimethyldioctylphosphonium iodide, dimethyldioctylphosphonium bromide, dimethyldioctylphosphonium chloride, dimethyldinonylphosphonium iodide, dimethyldinonylphosphonium bromide, dimethyldinonylphosphonium chloride, didecyldimethylphosphonium iodide, didecyldimethylphosphonium bromide, didecyldimethylphosphonium chloride, didodecyldimethylphosphonium iodide, didodecyldimethylphosphonium bromide, didodecyldimethylphosphonium chloride, dimethylditetradecylphosphonium iodide, dimethylditetradecylphosphonium bromide, dimethylditetradecylphosphonium chloride, dihexadecyldimethylphosphonium iodide, dihexadecyldimethylphosphonium bromide, dihexadecyldimethylphosphonium chloride, dimethyldioctadecylphosphonium iodide, dimethyloctadecylphosphonium bromide, dimethyloctadecylphosphonium chloride, diethyldipropylphosphonium iodide, diethyldipropylphosphonium bromide, diethyldipropylphosphonium chloride, dibutyldiethylphosphonium iodide, dibutyldiethylphosphonium bromide, dibutyldiethylphosphonium chloride, diethyldipentylphosphonium iodide, diethyldipentylphosphonium bromide, diethyldipentylphosphonium chloride, diethyldihexylphosphonium iodide, diethyldihexylphosphonium bromide, diethyldihexylphosphonium chloride, diethyldiphenylphosphonium iodide, diethyldiphenylphosphonium bromide, diethyldiphenylphosphonium chloride, diheptyldiethylphosphonium iodide, diheptyldiethylphosphonium bromide, diheptyldiethylphosphonium chloride, dibenzyldiethylphosphonium iodide, dibenzyldiethylphosphonium bromide, dibenzyldiethylphosphonium chloride, diethyldioctylphosphonium iodide, diethyldioctylphosphonium bromide, diethyldioctylphosphonium chloride, diethyldinonylphosphonium iodide, diethyldinonylphosphonium bromide, diethyldinonylphosphonium chloride, didecyldiethylphosphonium iodide, didecyldiethylphosphonium bromide, didecyldiethylphosphonium chloride, didodecyldiethylphosphonium iodide, didodecyldiethylphosphonium bromide, didodecyldiethylphosphonium chloride, diethylditetradecylphosphonium iodide, diethylditetradecylphosphonium bromide, diethylditetradecylphosphonium iodide, diethyldihexadecylphosphonium iodide, diethyldihexadecylphosphonium bromide, diethyldihexadecylphosphonium chloride, diethyldioctadecylphosphonium iodide, diethyldioctadecylphosphonium bromide, diethyldioctadecylphosphonium chloride, dibutyldipropylphosphonium iodide, dibutyldipropylphosphonium bromide, dibutyldipropylphosphonium chloride, dipentyldipropylphosphonium iodide, dipentyldipropylphosphonium bromide, dipentyldipropylphosphonium iodide, dihexyldipropylphosphonium iodide, dihexyldipropylphosphonium bromide, dihexyldipropylphosphonium chloride, dipropyldiphenylphosphonium iodide, dipropyldiphenylphosphonium bromide, dipropyldiphenylphosphonium chloride, diheptyldipropylphosphonium iodide, diheptyldipropylphosphonium bromide, diheptyldipropylphosphonium chloride, dibenzyldipropylphosphonium iodide, dibenzyldipropylphosphonium bromide, dibenzyldipropylphosphonium chloride, dipropyldioctylphosphonium iodide, dipropyldioctylphosphonium bromide, dipropyldioctylphosphonium chloride, dipropyldinonylphosphonium iodide, dipropyldinonylphosphonium bromide, dipropyldinonylphosphonium chloride, didecyldipropylphosphonium iodide, didecyldipropylphosphonium bromide, didecyldipropylphosphonium chloride, didodecyldipropylphosphonium iodide, didodecyldipropylphosphonium bromide, didodecyldipropylphosphonium chloride, dipropylditetradecylphosphonium iodide, dipropylditetradecylphosphonium bromide, dipropylditetradecylphosphonium chloride, dihexadecyldipropylphosphonium iodide, dihexadecyldipropylphosphonium bromide, dihexadecyldipropylphosphonium chloride, dipropyldioctadecylphosphonium iodide, dipropyldioctadecylphosphonium bromide, dipropyldioctadecylphosphonium chloride, dibutyldipentylphosphonium iodide, dibutyldipentylphosphonium bromide, dibutyldipentylphosphonium chloride, dibutyldihexylphosphonium iodide, dibutyldihexylphosphonium bromide, dibutyldihexylphosphonium chloride, dibutyldiphenylphosphonium iodide, dibutyldiphenylphosphonium bromide, dibutyldiphenylphosphonium chloride, diheptyldibutylphosphonium iodide, diheptyldibutylphosphonium bromide, diheptyldibutylphosphonium chloride, dibenzyldibutylphosphonium iodide, dibenzyldibutylphosphonium bromide, dibenzyldibutylphosphonium chloride, dibutyldioctylphosphonium iodide, dibutyldioctylphosphonium bromide, dibutyldioctylphosphonium chloride, dibutyldinonylphosphonium iodide, dibutyldinonylphosphonium bromide, dibutyldinonylphosphonium chloride, dibutyldidecylphosphonium iodide, dibutyldidecylphosphonium bromide, dibutyldidecylphosphonium chloride, dibutyldidodecylphosphonium iodide, dibutyldidodecylphosphonium bromide, dibutyldidodecylphosphonium chloride, dibutylditetradecylphosphonium iodide, dibutylditetradecylphosphonium bromide, dibutylditetradecylphosphonium chloride, dibutyldihexadecylphosphonium iodide, dibutyldihexadecylphosphonium bromide, dibutyldihexadecylphosphonium chloride, dibutyldioctadecylphosphonium iodide, dibutyldioctadecylphosphonium bromide, dibutyldioctadecylphosphonium chloride, dihexyldipentylphosphonium iodide, dihexyldipentylphosphonium bromide, dihexyldipentylphosphonium chloride, dipentyldiphenylphosphonium iodide, dipentyldiphenylphosphonium bromide, dipentyldiphenylphosphonium chloride, diheptyldipentylphosphonium iodide, diheptyldipentylphosphonium bromide, diheptyldipentylphosphonium chloride, dibenzyldipentylphosphonium iodide, dibenzyldipentylphosphonium bromide, dibenzyldipentylphosphonium chloride, dipentyldioctylphosphonium iodide, dipentyldioctylphosphonium bromide, dipentyldioctylphosphonium chloride, dipentyldinonylphosphonium iodide, dipentyldinonylphosphonium bromide, dipentyldinonylphosphonium chloride, didecyldipentylphosphonium iodide, didecyldipentylphosphonium bromide, didecyldipentylphosphonium chloride, didodecyldipentylphosphonium iodide, didodecyldipentylphosphonium bromide, didodecyldipentylphosphonium chloride, dipentylditetradecylphosphonium iodide, dipentylditetradecylphosphonium bromide, dipentylditetradecylphosphonium chloride, dihexadecyldipentylphosphonium iodide, dihexadecyldipentylphosphonium bromide, dihexadecyldipentylphosphonium chloride, dipentyldioctadecylphosphonium iodide, dipentyldioctadecylphosphonium bromide, dipentyldioctadecylphosphonium chloride, dihexyldiphenylphosphonium iodide, dihexyldiphenylphosphonium bromide, dihexyldiphenylphosphonium chloride, diheptyldihexylphosphonium iodide, diheptyldihexylphosphonium bromide, diheptyldihexylphosphonium chloride, dibenzyldihexylphosphonium iodide, dibenzyldihexylphosphonium bromide, dibenzyldihexylphosphonium chloride, dihexyldioctylphosphonium iodide, dihexyldioctylphosphonium bromide, dihexyldioctylphosphonium chloride, dihexyldinonylphosphonium iodide, dihexyldinonylphosphonium bromide, dihexyldinonylphosphonium chloride, didecyldihexylphosphonium iodide, didecyldihexylphosphonium bromide, didecyldihexylphosphonium chloride, didodecyldihexylphosphonium iodide, didodecyldihexylphosphonium bromide, didodecyldihexylphosphonium chloride, dihexylditetradecylphosphonium iodide, dihexylditetradecylphosphonium bromide, dihexylditetradecylphosphonium chloride, dihexadecyldihexylphosphonium iodide, dihexadecyldihexylphosphonium bromide, dihexadecyldihexylphosphonium chloride, dihexyldioctadecylphosphonium iodide, dihexyldioctadecylphosphonium bromide, dihexyldioctadecylphosphonium chloride, diheptyldiphenylphosphonium iodide, diheptyldiphenylphosphonium bromide, diheptyldiphenylphosphonium chloride, dibenzyldiphenylphosphonium iodide, dibenzyldiphenylphosphonium bromide, dibenzyldiphenylphosphonium chloride, dioctyldiphenylphosphonium iodide, dioctyldiphenylphosphonium bromide, dioctyldiphenylphosphonium chloride, dinonyldiphenylphosphonium iodide, dinonyldiphenylphosphonium bromide, dinonyldiphenylphosphonium chloride, didecyldiphenylphosphonium iodide, didecyldiphenylphosphonium bromide, didecyldiphenylphosphonium chloride, didodecyldiphenylphosphonium iodide, didodecyldiphenylphosphonium bromide, didodecyldiphenylphosphonium chloride, diphenylditetradecylphosphonium iodide, diphenylditetradecylphosphonium bromide, diphenylditetradecylphosphonium chloride, dihexadecyldiphenylphosphonium iodide, dihexadecyldiphenylphosphonium bromide, dihexadecyldiphenylphosphonium chloride, diphenyldioctadecylphosphonium iodide, diphenyldioctadecylphosphonium bromide, diphenyldioctadecylphosphonium chloride, dibenzyldiheptylphosphonium iodide, dibenzyldiheptylphosphonium bromide, dibenzyldiheptylphosphonium chloride, diheptyldioctylphosphonium iodide, diheptyldioctylphosphonium bromide, diheptyldioctylphosphonium chloride, diheptyldinonylphosphonium iodide, diheptyldinonylphosphonium bromide, diheptyldinonylphosphonium chloride, didecyldiheptylphosphonium iodide, didecyldiheptylphosphonium bromide, didecyldiheptylphosphonium chloride, didodecyldiheptylphosphonium iodide, didodecyldiheptylphosphonium bromide, didodecyldiheptylphosphonium chloride, diheptylditetradecylphosphonium iodide, diheptylditetradecylphosphonium bromide, diheptylditetradecylphosphonium chloride, diheptyldihexadecylphosphonium iodide, diheptyldihexadecylphosphonium bromide, diheptyldihexadecylphosphonium chloride, diheptyldioctadecylphosphonium iodide, diheptyldioctadecylphosphonium bromide, diheptyldioctadecylphosphonium chloride, dibenzyldioctylphosphonium iodide, dibenzyldioctylphosphonium bromide, dibenzyldioctylphosphonium chloride, dibenzyldinonylphosphonium iodide, dibenzyldinonylphosphonium bromide, dibenzyldinonylphosphonium chloride, dibenzyldidecylphosphonium iodide, dibenzyldidecylphosphonium bromide, dibenzyldidecylphosphonium chloride, dibenzyldidodecylphosphonium iodide, dibenzyldidodecylphosphonium bromide, dibenzyldidodecylphosphonium chloride, dibenzylditetradecylphosphonium iodide, dibenzylditetradecylphosphonium bromide, dibenzylditetradecylphosphonium chloride, dibenzyldihexadecylphosphonium iodide, dibenzyldihexadecylphosphonium bromide, dibenzyldihexadecylphosphonium chloride, dibenzyldiocatadecylphosphonium iodide, dibenzyldiocatadecylphosphonium bromide, dibenzyldiocatadecylphosphonium chloride, benzylethyldimethylphosphonium iodide, benzylethyldimethylphosphonium bromide, benzylethyldimethylphosphonium chloride, benzylpropyldimethylphosphonium iodide, benzylpropyldimethylphosphonium bromide, benzylpropyldimethylphosphonium chloride, benzylbutyldimethylphosphonium iodide, benzylbutyldimethylphosphonium bromide, benzylbutyldimethylphosphonium chloride, benzyldimethylpentylphosphonium iodide, benzyldimethylpentylphosphonium bromide, benzyldimethylpentylphosphonium chloride, benzylhexyldimethylphosphonium iodide, benzylhexyldimethylphosphonium bromide, benzylhexyldimethylphosphonium chloride, benzylheptyldimethylphosphonium iodide, benzylheptyldimethylphosphonium bromide, benzylheptyldimethylphosphonium chloride, benzyldimethyloctylphosphonium iodide, benzyldimethyloctylphosphonium bromide, benzyldimethyloctylphosphonium chloride, benzyldimethylnonylphosphonium iodide, benzyldimethylnonylphosphonium bromide, benzyldimethylnonylphosphonium chloride, benzyldecyldimethylphosphonium iodide, benzyldecyldimethylphosphonium bromide, benzyldecyldimethylphosphonium chloride, benzyldimethylundecylphosphonium iodide, benzyldimethylundecylphosphonium bromide, benzyldimethylundecylphosphonium chloride, benzyldodecyldimethylphosphonium iodide, benzyldodecyldimethylphosphonium bromide, benzyldodecyldimethylphosphonium chloride, benzyldimethyltetradecylphosphonium iodide, benzyldimethyltetradecylphosphonium bromide, benzyldimethyltetradecylphosphonium chloride, dibenzylhexadecyldimethylphosphonium iodide, dibenzylhexadecyldimethylphosphonium bromide, dibenzylhexadecyldimethylphosphonium chloride, dibenzyloctadecyldimethylphosphonium iodide, dibenzyloctadecyldimethylphosphonium bromide, dibenzyloctadecyldimethylphosphonium chloride, tetramethylammonium iodide, tetramethylammonium bromide, tetramethylammonium chloride, tetraethylammonium iodide, tetraethylammonium bromide, tetraethylammonium chloride, tetrapropylammonium iodide, tetrapropylammonium bromide, tetrapropylammonium chloride, tetrabutylammonium iodide, tetrabutylammonium bromide, tetrabutylammonium chloride, terapentylammonium iodide, terapentylammonium bromide, terapentylammonium chloride, tetrahexylammonium iodide, tetrahexylammonium bromide, tetrahexylammonium chloride, tetraphenylammonium iodide, tetraphenylammonium bromide, tetraphenylammonium chloride, tetraheptylammonium iodide, tetraheptylammonium bromide, tetraheptylammonium chloride, tetrabenzylammonium iodide, tetrabenzylammonium bromide, tetrabenzylammonium chloride, tetraoctylammonium iodide, tetraoctylammonium bromide, tetraoctylammonium chloride, tetranonylammonium iodide, tetranonylammonium bromide, tetranonylammonium chloride, tetrakisdecylammonium iodide, tetrakisdecylammonium bromide, tetrakisdecylammonium chloride, tetradodecylammonium iodide, tetradodecylammonium bromide, tetradodecylammonium chloride, tetrakistetradecylammonium iodide, tetrakistetradecylammonium bromide, tetrakistetradecylammonium chloride, tetrakishexadecylammonium iodide, tetrakishexadecylammonium bromide, tetrakishexadecylammonium iodide, tetrakisoctadecylammonium iodide, tetrakisoctadecylammonium bromide, tetrakisoctadecylammonium chloride, trimethylpropylammonium iodide, trimethylpropylammonium bromide, trimethylpropylammonium chloride, butyltrimethylammonium iodide, butyltrimethylammonium bromide, butyltrimethylammonium chloride, trimethylpentylammonium iodide, trimethylpentylammonium bromide, trimethylpentylammonium chloride, hexyltrimethylammonium iodide, hexyltrinmethylammonium bromide, hexyltrimethylammonium chloride, heptyltrimethylammonium iodide, trimethylphenylammonium iodide, trimethylphenylammonium bromide, trimethylphenylammonium chloride, heptyltrinetyylammonium bromide, heptyltrimetyylammonium chloride, benzyltrimethylammonium iodide, benzyltrimethylammonium bromide, benzyltrimethylammonium chloride, trimethyloctylammonium iodide, trimethyloctylammonium bromide, trimethyloctylammonium chloride, trimethyylnonylammonium iodide, trimethyylnonylammonium bromide, trimethyylnonylammonium chloride, decyltrimethylammonium iodide, decyltrimethylammonium bromide, decyltrimethylammonium chloride, trimethylundecylammonium iodide, trimethylundecylammonium bromide, trimethylundecylammonium chloride, dodecyltrimethylammonium iodide, dodecyltrimethylammonium bromide, dodecyltrimethylammonium chloride, trimethyltetradecylammonium iodide, trimethyltetradecylammonium bromide, trimethyltetradecylammonium chloride, hexadecyltrimethylammonium iodide, hexadecyltrimethylammonium bromide, hexadecyltrimethylammonium chloride, trimethylocatadecylammonium iodide, trimethylocatadecylammonium bromide, trimethylocatadecylammonium chloride, triethylmethylammonium iodide, triethylmethylammonium bromide, triethylmethylammonium chloride, triethylpropylammonium iodide, triethylpropylammonium bromide, triethylpropylammonium chloride, triethylbutylammonium iodide, triethylbutylammonium bromide, triethylbutylammonium chloride, triethylpentylammonium iodide, triethylpentylammonium bromide, triethylpentylammonium chloride, triethylhexylammonium iodide, triethylhexylammonium bromide, triethylhexylammonium chloride, triethylphenylammonium iodide, triethylphenylammonium bromide, triethylphenylammonium chloride, triethylheptylammonium iodide, triethylheptylammonium bromide, triethylheptylammonium chloride, benzyltriethylammonium iodide, benzyltriethylammonium bromide, benzyltriethylammonium chloride, triethyloctylammonium iodide, triethyloctylammonium bromide, triethyloctylammonium chloride, triethylnonylammonium iodide, triethylnonylammonium bromide, triethylnonylammonium chloride, triethyldecylammonium iodide, triethyldecylammonium bromide, triethyldecylammonium chloride, triethylundecylammonium iodide, triethylundecylammonium bromide, triethylundecylammonium chloride, triethyldodecylammonium iodide, triethyldodecylammonium bromide, triethyldodecylammonium chloride, triethyltetradecylammonium iodide, triethyltetradecylammonium bromide, triethyltetradecylammonium chloride, triethylhexadecylammonium iodide, triethylhexadecylammonium bromide, triethylhexadecylammonium chloride, triethyloctadecylammonium iodide, triethyloctadecylammonium bromide, triethyloctadecylammonium chloride, methyltripropylammonium iodide, methyltripropylammonium bromide, methyltripropylammonium chloride, ethyltripropylammonium iodide, ethyltripropylammonium bromide, ethyltripropylammonium chloride, butyltripropylammonium iodide, butyltripropylammonium bromide, butyltripropylammonium chloride, pentyltripropylammonium iodide, pentyltripropylammonium bromide, pentyltripropylammonium chloride, hexyltripropylammonium iodide, hexyltripropylammonium bromide, hexyltripropylammonium chloride, phenyltripropylammonium iodide, phenyltripropylammonium bromide, phenyltripropylammonium chloride, heptyltripropylammonium iodide, heptyltripropylammonium bromide, heptyltripropylammonium chloride, benzyltripropylammonium iodide, benzyltripropylammonium bromide, benzyltripropylammonium chloride, octyltripropylammonium iodide, octyltripropylammonium bromide, octyltripropylammonium chloride, nonyltripropylammonium iodide, nonyltripropylammonium bromide, nonyltripropylammonium chloride, decyltripropylammonium iodide, decyltripropylammonium bromide, decyltripropylammonium chloride, tripropylundecylammonium iodide, tripropylundecylammonium bromide, tripropylundecylammonium chloride, dodecyltirpropylammonium iodide, dodecyltirpropylammonium bromide, dodecyltirpropylammonium chloride, tetradecyltripropylammonium iodide, tetradecyltripropylammonium bromide, tetradecyltripropylammonium chloride, hexadecyltripropylammonium iodide, hexadecyltripropylammonium bromide, hexadecyltripropylammonium chloride, octadecyltripropylammonium iodide, octadecyltripropylammonium bromide, octadecyltripropylammonium chloride, tributylmethylammonium iodide, tributylmethylammonium bromide, tributylmethylammonium chloride, tributylethylammonium iodide, tributylethylammonium bromide, tributylethylammonium chloride, tributylpropylammonium iodide, tributylpropylammonium bromide, tributylpropylammonium chloride, tributylpentylammonium iodide, tributylpentylammonium bromide, tributylpentylammonium chloride, tributylhexylammonium iodide, tributylhexylammonium bromide, tributylhexylammonium chloride, tributylphenylammonium iodide, tributylphenylammonium bromide, tributylphenylammonium chloride, tributylheptylammonium iodide, tributylheptylammonium bromide, tributylheptylammonium chloride, benzyltributylammonium iodide, benzyltributylammonium bromide, benzyltributylammonium chloride, tributyloctylammonium iodide, tributyloctylammonium bromide, tributyloctylammonium chloride, tributylnonylammonium iodide, tributylnonylammonium bromide, tributylnonylammonium chloride, tributyldecylammonium iodide, tributyldecylammonium bromide, tributyldecylammonium chloride, tributylundecylammonium iodide, tributylundecylammonium bromide, tributylundecylammonium chloride, tributyldodecylammonium iodide, tributyldodecylammonium bromide, tributyldodecylammonium chloride, tributyltetradecylammonium iodide, tributyltetradecylammonium bromide, tributyltetradecylammonium chloride, tributylhexadecylammonium iodide, tributylhexadecylammonium bromide, tributylhexadecylammonium chloride, tributylocatadecylammonium iodide, tributylocatadecylammonium bromide, tributylocatadecylammonium chloride, methyltripentylammonium iodide, methyltripentylammonium bromide, methyltripentylammonium chloride, ethyltripenthylammonium iodide, ethyltripenthylammonium bromide, ethyltripenthylammonium chloride, tripentylpropylammonium iodide, tripentylpropylammonium bromide, tripentylpropylammonium chloride, butyltripentylammonium iodide, butyltripentylammonium bromide, butyltripentylammonium chloride, hexyltripentylammonium iodide, hexyltripentylammonium bromide, hexyltripentylammonium chloride, tripentylphenylammonium iodide, tripentylphenylammonium bromide, tripentylphenylammonium chloride, heptyltripentylammonium iodide, heptyltripentylammonium bromide, heptyltripentylammonium chloride, benzyltripentylammonium iodide, benzyltripentylammonium bromide, benzyltripentylammonium chloride, octyltripentylammonium iodide, octyltripentylammonium bromide, octyltripentylammonium chloride, nonyltripentylammonium iodide, nonyltripentylammonium bromide, nonyltripentylammonium chloride, decyltripentylammonium iodide, decyltripentylammonium bromide, decyltripentylammonium chloride, tripentylundecylammonium iodide, tripentylundecylammonium bromide, tripentylundecylammonium chloride, dodecyltripentylammonium iodide, dodecyltripentylammonium bromide, dodecyltripentylammonium chloride, tetradecyltripentylammonium iodide, dodecyltripentylammonium bromide, dodecyltripentylammonium chloride, tripentyltetradecylammonium iodide, tripentyltetradecylammonium bromide, tripentyltetradecylammonium chloride, hexadecyltripentylammonium iodide, hexadecyltripentylammonium bromide, hexadecyltripentylammonium chloride, octadecyltripentylammonium iodide, octadecyltripentylammonium bromide, octadecyltripentylammonium chloride, trihexylmethylammonium iodide, trihexylmethylammonium bromide, trihexylmethylammonium chloride, ethyltrihexylammonium iodide, ethyltrihexylammonium bromide, ethyltrihexylammonium chloride, trihexylpropylammonium iodide, trihexylpropylammonium bromide, trihexylpropylammonium chloride, butyltrihexylammonium iodide, butyltrihexylammonium bromide, butyltrihexylammonium chloride, trihexylpentylammonium iodide, trihexylpentylammonium bromide, trihexylpentylammonium chloride, trihexylphenylammonium iodide, trihexylphenylammonium bromide, trihexylphenylammonium chloride, heptyltrihexylammonium iodide, heptyltrihexylammonium bromide, heptyltrihexylammonium chloride, benzyltrihexylammonium iodide, benzyltrihexylammonium bromide, benzyltrihexylammonium chloride, trihexyloctylammonium iodide, trihexyloctylammonium bromide, trihexyloctylammonium chloride, trihexylnonylammonium iodide, trihexylnonylammonium bromide, trihexylnonylammonium chloride, decyltrihexylammonium iodide, decyltrihexylammonium bromide, decyltrihexylammonium chloride, trihexylundecylammonium iodide, trihexylundecylammonium bromide, trihexylundecylammonium chloride, dodecyltrihexylammonium iodide, dodecyltrihexylammonium bromide, dodecyltrihexylammonium chloride, trihexyltetradecylammonium iodide, trihexyltetradecylammonium bromide, trihexyltetradecylammonium chloride, hexadecyltrihexylammonium iodide, hexadecyltrihexylammonium bromide, hexadecyltrihexylammonium chloride, trihexyloctadecylammonium iodide, trihexyloctadecylammonium bromide, trihexyloctadecylammonium chloride, methyltriphenylammonium iodide, methyltriphenylammonium bromide, methyltriphenylammonium chloride, ethyltriphenylammonium iodide, ethyltriphenylammonium bromide, ethyltriphenylammonium chloride, triphenylpropylammonium iodide, triphenylpropylammonium bromide, triphenylpropylammonium chloride, butyltriphenylammonium iodide, butyltriphenylammonium bromide, butyltriphenylammonium chloride, hexyltriphenylammonium iodide, hexyltriphenylammonium bromide, hexyltriphenylammonium chloride, pentyltriphenylammonium iodide, pentyltriphenylammonium bromide, pentyltriphenylammonium chloride, hexyltriphenylphsophonium iodide, hexyltriphenylphsophonium bromide, hexyltriphenylphsophonium chloride, heptyltriphenylammonium iodide, heptyltriphenylammonium bromide, heptyltriphenylammonium chloride, benzyltriphenylammonium iodide, benzyltriphenylammonium bromide, benzyltriphenylammonium chloride, octyltriphenylammonium iodide, octyltriphenylammonium bromide, octyltriphenylammonium chloride, nonyltriphenylammonium iodide, nonyltriphenylammonium bromide, nonyltriphenylammonium chloride, decyltriphenylammonium iodide, decyltriphenylammonium bromide, decyltriphenylammonium chloride, triphenyldecylammonium iodide, triphenyldecylammonium bromide, triphenyldecylammonium chloride, dodecyltriphenylammonium iodide, dodecyltriphenylammonium bromide, dodecyltriphenylammonium chloride, tetradecyltriphenylammonium iodide, dodecyltriphenylammonium bromide, dodecyltriphenylammonium chloride, triphenyltetradecylammonium iodide, triphenyltetradecylammonium bromide, triphenyltetradecylammonium chloride, hexadecyltriphenylammonium iodide, hexadecyltriphenylammonium bromide, hexadecyltriphenylammonium chloride, octadecyltriphenylammonium iodide, octadecyltriphenylammonium bromide, octadecyltriphenylammonium chloride, triheptylmethylammonium iodide, triheptylmethylammonium bromide, triheptylmethylammonium chloride, ethyltriheptylammonium iodide, ethyltriheptylammonium bromide, ethyltriheptylammonium chloride, triheptylpropylammonium iodide, triheptylpropylammonium bromide, triheptylpropylammonium chloride, butyltriheptylammonium iodide, butyltriheptylammonium bromide, butyltriheptylammonium chloride, triheptylpentylammonium iodide, triheptylpentylammonium bromide, triheptylpentylammonium chloride, triheptylhexylammonium iodide, triheptylhexylammonium bromide, triheptylhexylammonium chloride, triheptyloctylammonium iodide, triheptyloctylammonium bromide, triheptyloctylammonium chloride, triheptylnonylammonium iodide, triheptylnonylammonium bromide, triheptylnonylammonium chloride, decyltriheptylammonium iodide, decyltriheptylammonium bromide, decyltriheptylammonium chloride, triheptylundecylammonium iodide, triheptylundecylammonium bromide, triheptylundecylammonium chloride, dodecyltriheptylammonium iodide, dodecyltriheptylammonium bromide, dodecyltriheptylammonium chloride, triheptyltetradecylammonium iodide, triheptyltetradecylammonium bromide, triheptyltetradecylammonium chloride, triheptylhexadecylammonium iodide, triheptylhexadecylammonium bromide, triheptylhexadecylammonium chloride, tribenzylmethylammonium iodide, tribenzylmethylammonium bromide, tribenzylmethylammonium chloride, tribenzylethylammonium iodide, tribenzylethylammonium bromide, tribenzylethylammonium chloride, tribenzylpropylammonium iodide, tribenzylpropylammonium bromide, tribenzylpropylammonium chloride, tribenzylbutylammonium iodide, tribenzylbutylammonium bromide, tribenzylbutylammonium chloride, tribenzylpentylammonium iodide, tribenzylpentylammonium bromide, tribenzylpentylammonium chloride, tribenzylhexylammonium iodide, tribenzylhexylammonium bromide, tribenzylhexylammonium chloride, tribenzylphenylammonium iodide, tribenzylphenylammonium bromide, tribenzylphenylammonium chloride, tribenzylheptylammonium iodide, tribenzylheptylammonium bromide, tribenzylheptylammonium chloride, tribenzyloctylammonium iodide, tribenzyloctylammonium bromide, tribenzyloctylammonium chloride, tribenzylnonylammonium iodide, tribenzylnonylammonium bromide, tribenzylnonylammonium chloride, tribenzyldecylammonium iodide, tribenzyldecylammonium bromide, tribenzyldecylammonium chloride, tribenzyldecylammonium iodide, tribenzyldecylammonium bromide, tribenzyldecylammonium chloride, tribenzyldecylammonium iodide, tribenzyldecylammonium bromide, tribenzyldecylammonium chloride, tribenzyltetradecylammonium iodide, tribenzyltetradecylammonium bromide, tribenzyltetradecylammonium chloride, tribenzylhexadecylammonium iodide, tribenzylhexadecylammonium bromide, tribenzylhexadecylammonium chloride, tribenzyloctadecylammonium iodide, tribenzyloctadecylammonium bromide, tribenzyloctadecylammonium chloride, methyltrioctylammonium iodide, methyltrioctylammonium bromide, methyltrioctylammonium chloride, ethyltrioctylammonium iodide, ethyltrioctylammonium bromide, ethyltrioctylammonium chloride, trioctylpropylammonium iodide, trioctylpropylammonium bromide, trioctylpropylammonium chloride, butyltrioctylammonium iodide, butyltrioctylammonium bromide, butyltrioctylammonium chloride, trioctylpentylammonium iodide, trioctylpentylammonium bromide, trioctylpentylammonium chloride, hexyltrioctylammonium iodide, hexyltrioctylammonium bromide, hexyltrioctylammonium chloride, heptyltrioctylammonium iodide, heptyltrioctylammonium bromide, heptyltrioctylammonium chloride, nonyltrioctylammonium iodide, nonyltrioctylammonium bromide, nonyltrioctylammonium chloride, decyltrioctylammonium iodide, decyltrioctylammonium bromide, decyltrioctylammonium chloride, trioctylundecylammonium iodide, trioctylundecylammonium bromide, trioctylundecylammonium chloride, dodecyltrioctylammonium iodide, dodecyltrioctylammonium bromide, dodecyltrioctylammonium chloride, trioctyltetradecylammonium iodide, trioctyltetradecylammonium bromide, trioctyltetradecylammonium chloride, hexadecyltrioctylammonium iodide, hexadecyltrioctylammonium bromide, hexadecyltrioctylammonium chloride, octadecyltrioctylammonium iodide, octadecyltrioctylammonium bromide, octadecyltrioctylammonium chloride, diethyldimethylammonium iodide, diethyldimethylammonium bromide, diethyldimethylammonium chloride, dimethyldipropylammonium iodide, dimethyldipropylammonium bromide, dimethyldipropylammonium chloride, dibutyldimethylammonium iodide, dibutyldimethylammonium bromide, dibutyldimethylammonium chloride, dimethylpentylammonium iodide, dimethylpentylammonium bromide, dimethylpentylammonium chloride, dihexyldimethylammonium iodide, dihexyldimethylammonium bromide, dihexyldimethylammonium chloride, dimethyldiphenylammonium iodide, dimethyldiphenylammonium bromide, dimethyldiphenylammonium chloride, diheptyldimethylammonium iodide, diheptyldimethylammonium bromide, diheptyldimethylammonium chloride, dibenzyldimethylammonium iodide, dibenzyldimethylammonium bromide, dibenzyldimethylammonium chloride, dimethyldioctylammonium iodide, dimethyldioctylammonium bromide, dimethyldioctylammonium chloride, dimethyldinonylammonium iodide, dimethyldinonylammonium bromide, dimethyldinonylammonium chloride, didecyldimethylammonium iodide, didecyldimethylammonium bromide, didecyldimethylammonium chloride, didodecyldimethylammonium iodide, didodecyldimethylammonium bromide, didodecyldimethylammonium chloride, dimethylditetradecylammonium iodide, dimethylditetradecylammonium bromide, dimethylditetradecylammonium chloride, dihexadecyldimethylammonium iodide, dihexadecyldimethylammonium bromide, dihexadecyldimethylammonium chloride, dimethyldioctadecylammonium iodide, dimethyloctadecylammonium bromide, dimethyloctadecylammonium chloride, diethyldipropylammonium iodide, diethyldipropylammonium bromide, diethyldipropylammonium chloride, dibutyldiethylammonium iodide, dibutyldiethylammonium bromide, dibutyldiethylammonium chloride, diethyldipentylammonium iodide, diethyldipentylammonium bromide, diethyldipentylammonium chloride, diethyldihexylammonium iodide, diethyldihexylammonium bromide, diethyldihexylammonium chloride, diethyldiphenylammonium iodide, diethyldiphenylammonium bromide, diethyldiphenylammonium chloride, diheptyldiethylammonium iodide, diheptyldiethylammonium bromide, diheptyldiethylammonium chloride, dibenzyldiethylammonium iodide, dibenzyldiethylammonium bromide, dibenzyldiethylammonium chloride, diethyldioctylammonium iodide, diethyldioctylammonium bromide, diethyldioctylammonium chloride, diethyldinonylammonium iodide, diethyldinonylammonium bromide, diethyldinonylammonium chloride, didecyldiethylammonium iodide, didecyldiethylammonium bromide, didecyldiethylammonium chloride, didodecyldiethylammonium iodide, didodecyldiethylammonium bromide, didodecyldiethylammonium chloride, diethylditetradecylammonium iodide, diethylditetradecylammonium bromide, diethylditetradecylammonium chloride, diethyldihexadecylammonium iodide, diethyldihexadecylammonium bromide, diethyldihexadecylammonium chloride, diethyldioctadecylammonium iodide, diethyldioctadecylammonium bromide, diethyldioctadecylammonium chloride, dibutyldipropylammonium iodide, dibutyldipropylammonium bromide, dibutyldipropylammonium chloride, dipentyldipropylammonium iodide, dipentyldipropylammonium bromide, dipentyldipropylammonium chloride, dihexyldipropylammonium iodide, dihexyldipropylammonium bromide, dihexyldipropylammonium chloride, dipropyldiphenylammonium iodide, dipropyldiphenylammonium bromide, dipropyldiphenylammonium chloride, diheptyldipropylammonium iodide, diheptyldipropylammonium bromide, diheptyldipropylammonium chloride, dibenzyldipropylammonium iodide, dibenzyldipropylammonium bromide, dibenzyldipropylammonium chloride, dipropyldioctylammonium iodide, dipropyldioctylammonium bromide, dipropyldioctylammonium chloride, dipropyldinonylammonium iodide, dipropyldinonylammonium bromide, dipropyldinonylammonium chloride, didecyldipropylammonium iodide, didecyldipropylammonium bromide, didecyldipropylammonium chloride, didodecyldipropylammonium iodide, didodecyldipropylammonium bromide, didodecyldipropylammonium chloride, dipropylditetradecylammonium iodide, dipropylditetradecylammonium bromide, dipropylditetradecylammonium chloride, dihexadecyldipropylammonium iodide, dihexadecyldipropylammonium bromide, dihexadecyldipropylammonium chloride, dipropyldioctadecylammonium iodide, dipropyldioctadecylammonium bromide, dipropyldioctadecylammonium chloride, dibutyldipentylammonium iodide, dibutyldipentylammonium bromide, dibutyldipentylammonium chloride, dibutyldihexylammonium iodide, dibutyldihexylammonium bromide, dibutyldihexylammonium chloride, dibutyldiphenylammonium iodide, dibutyldiphenylammonium bromide, dibutyldiphenylammonium chloride, diheptyldibutylammonium iodide, diheptyldibutylammonium bromide, diheptyldibutylammonium chloride, dibenzyldibutylammonium iodide, dibenzyldibutylammonium bromide, dibenzyldibutylammonium chloride, dibutyldioctylammonium iodide, dibutyldioctylammonium bromide, dibutyldioctylammonium chloride, dibutyldinonylammonium iodide, dibutyldinonylammonium bromide, dibutyldinonylammonium chloride, dibutyldidecylammonium iodide, dibutyldidecylammonium bromide, dibutyldidecylammonium chloride, dibutyldidodecylammonium iodide, dibutyldidodecylammonium bromide, dibutyldidodecylammonium chloride, dibutylditetradecylammonium iodide, dibutylditetradecylammonium bromide, dibutylditetradecylammonium chloride, dibutyldihexadecylammonium iodide, dibutyldihexadecylammonium bromide, dibutyldihexadecylammonium chloride, dibutyldioctadecylammonium iodide, dibutyldioctadecylammonium bromide, dibutyldioctadecylammonium chloride, dihexyldipentylammonium iodide, dihexyldipentylammonium bromide, dihexyldipentylammonium chloride, dipentyldiphenylammonium iodide, dipentyldiphenylammonium bromide, dipentyldiphenylammonium chloride, diheptyldipentylammonium iodide, diheptyldipentylammonium bromide, diheptyldipentylammonium chloride, dibenzyldipentylammonium iodide, dibenzyldipentylammonium bromide, dibenzyldipentylammonium chloride, dipentyldioctylammonium iodide, dipentyldioctylammonium bromide, dipentyldioctylammonium chloride, dipentyldinonylammonium iodide, dipentyldinonylammonium bromide, dipentyldinonylammonium chloride, didecyldipentylammonium iodide, didecyldipentylammonium bromide, didecyldipentylammonium chloride, didodecyldipentylammonium iodide, didodecyldipentylammonium bromide, didodecyldipentylammonium chloride, dipentylditetradecylammonium iodide, dipentylditetradecylammonium bromide, dipentylditetradecylammonium chloride, dihexadecyldipentylammonium iodide, dihexadecyldipentylammonium bromide, dihexadecyldipentylammonium chloride, dipentyldioctadecylammonium iodide, dipentyldioctadecylammonium bromide, dipentyldioctadecylammonium chloride, dihexyldiphenylammonium iodide, dihexyldiphenylammonium bromide, dihexyldiphenylammonium chloride, diheptyldihexylammonium iodide, diheptyldihexylammonium bromide, diheptyldihexylammonium chloride, dibenzyldihexylammonium iodide, dibenzyldihexylammonium bromide, dibenzyldihexylammonium chloride, dihexyldioctylammonium iodide, dihexyldioctylammonium bromide, dihexyldioctylammonium chloride, dihexyldinonylammonium iodide, dihexyldinonylammonium bromide, dihexyldinonylammonium chloride, didecyldihexylammonium iodide, didecyldihexylammonium bromide, didecyldihexylammonium chloride, didodecyldihexylammonium iodide, didodecyldihexylammonium bromide, didodecyldihexylammonium chloride, dihexylditetradecylammonium iodide, dihexylditetradecylammonium bromide, dihexylditetradecylammonium chloride, dihexadecyldihexylammonium iodide, dihexadecyldihexylammonium bromide, dihexadecyldihexylammonium chloride, dihexyldioctadecylammonium iodide, dihexyldioctadecylammonium bromide, dihexyldioctadecylammonium chloride, diheptyldiphenylammonium iodide, diheptyldiphenylammonium bromide, diheptyldiphenylammonium chloride, dibenzyldiphenylammonium iodide, dibenzyldiphenylammonium bromide, dibenzyldiphenylammonium chloride, dioctyldiphenylammonium iodide, dioctyldiphenylamnonium bromide, dioctyldiphenylammonium chloride, dinonyldiphenylammonium iodide, dinonyldiphenylammonium bromide, dinonyldiphenylammonium chloride, didecyldiphenylammonium iodide, didecyldiphenylammonium bromide, didecyldiphenylammonium chloride, didodecyldiphenylammonium iodide, didodecyldiphenylammonium bromide, didodecyldiphenylammonium chloride, diphenylditetradecylammonium iodide, diphenylditetradecylammonium bromide, diphenylditetradecylammonium chloride, dihexadecyldiphenylammonium iodide, dihexadecyldiphenylammonium bromide, dihexadecyldiphenylammonium chloride, diphenyldioctadecylammonium iodide, diphenyldioctadecylammonium bromide, diphenyldioctadecylammonium chloride, dibenzyldiheptylammonium iodide, dibenzyldiheptylammonium bromide, dibenzyldiheptylammonium chloride, diheptyldioctylammonium iodide, diheptyldioctylammonium bromide, diheptyldioctylammonium chloride, diheptyldinonylammonium iodide, diheptyldinonylammonium bromide, diheptyldinonylammonium chloride, didecyldiheptylammonium iodide, didecyldiheptylammonium bromide, didecyldiheptylammonium chloride, didodecyldiheptylammonium iodide, didodecyldiheptylammonium bromide, didodecyldiheptylammonium chloride, diheptylditetradecylammonium iodide, diheptylditetradecylammonium bromide, diheptylditetradecylammonium chloride, diheptyldihexadecylammonium iodide, diheptyldihexadecylammonium bromide, diheptyldihexadecylammonium chloride, diheptyldioctadecylammonium iodide, diheptyldioctadecylammonium bromide, diheptyldioctadecylammonium chloride, dibenzyldioctylammonium iodide, dibenzyldioctylammonium bromide, dibenzyldioctylammonium chloride, dibenzyldinonylammonium iodide, dibenzyldinonylammonium bromide, dibenzyldinonylammonium chloride, dibenzyldidecylammonium iodide, dibenzyldidecylammonium bromide, dibenzyldidecylammonium chloride, dibenzyldidodecylammonium iodide, dibenzyldidodecylammonium bromide, dibenzyldidodecylammonium chloride, dibenzylditetradecylammonium iodide, dibenzylditetradecylammonium bromide, dibenzylditetradecylammonium chloride, dienzyldihexadecylammonium iodide, dienzyldihexadecylammonium bromide, dienzyldihexadecylammonium chloride, dibenzyldiocatadecylammonium iodide, dibenzyldiocatadecylammonium bromide, dibenzyldiocatadecylammonium chloride, benzylethyldimethylammonium iodide, benzylethyldimethylammonium bromide, benzylethyldimethylammonium chloride, benzylpropyldimethylammonium iodide, benzylpropyldimethylammonium bromide, benzylpropyldimethylammonium chloride, benzylbutyldimethylammonium iodide, benzylbutyldimethylammonium bromide, benzylbutyldimethylammonium chloride, benzyldimethylpentylammonium iodide, benzyldimethylpentylammonium bromide, benzyldimethylpentylammonium chloride, benzylhexyldimethylammonium iodide, benzylhexyldimethylammonium bromide, benzylhexyldimethylammonium chloride, benzylheptyldimethylammonium iodide, benzylheptyldimethylammonium bromide, benzylheptyldimethylammonium chloride, benzyldimethyloctylammonium iodide, benzyldimethyloctylammonium bromide, benzyldimethyloctylammonium chloride, benzyldimethylnonylammonium iodide, benzyldimethylnonylammonium bromide, benzyldimethylnonylammonium chloride, benzyldecyldimethylammonium iodide, benzyldecyldimethylammonium bromide, benzyldecyldimethylammonium chloride, benzyldimethylundecylammonium iodide, benzyldimethylundecylammonium bromide, benzyldimethylundecylammonium chloride, bvenzyldodecyldimethylammonium iodide, bvenzyldodecyldimethylammonium bromide, bvenzyldodecyldimethylammonium chloride, benzyldimethyltetradecylammonium iodide, benzyldimethyltetradecylammonium bromide, benzyldimethyltetradecylammonium chloride, dibenzylhexadecyldimethylammonium iodide, dibenzylhexadecyldimethylammonium bromide, dibenzylhexadecyldimethylammonium chloride, dibenzyloctadecyldimethylammonium iodide, dibenzyloctadecyldimethylammonium bromide, dibenzyloctadecyldimethylammonium chloride, methylpyridinium iodide, methylpyridinium bromide, methylpyridinium chloride, ethylpyridinium iodide, ethylpyridinium bromide, ethylpyridinium chloride, propylpyridinium iodide, propylpyridinium bromide, propylpyridinium chloride, butylpyridinium iodide, butylpyridinium bromide, butylpyridinium chloride, pentylpyridinium iodide, pentylpyridinium bromide, pentylpyridinium chloride, hexylpyridmium iodide, hexylpyridinium bromide, hexylpyridinium chloride, heptylpyridinium iodide, heptylpyridinium bromide, heptylpyridinium chloride, octylpyridinium iodide, octylpyridinium bromide, octylpyridinium chloride, nonylpyridinium iodide, nonylpyridinium bromide, nonylpyridinium chloride, decylpyridinium iodide, decylpyridinium bromide, decylpyridinium chloride, undecylpyridinium iodide, undecylpyridinium bromide, undecylpyridinium chloride, dodecylpyridinium iodide, dodecylpyridinium bromide, dodecylpyridinium chloride, tetradecylpyridinium iodide, tetradecylpyridinium bromide, tetradecylpyridinium chloride, hexadecylpyridinium iodide, hexadecylpyridinium bromide, hexadecylpyridinium chloride, octadecylpyridinium iodide, octadecylpyridinium bromide, octadecylpyridinium chloride, 1,3-dimethylimidazolium iodide, 1,3-dimethylimidazolium bromide, 1,3-dimethylimidazolium chloride, 1-ethyl-3-methylimidazolium iodide, 1-ethyl-3-methylimidazolium bromide, 1-ethyl-3-methylimidazolium chloride, 1-propyl-3-methylimidazolium iodide, 1-propyl-3-methylimidazolium bromide, 1-propyl-3-methylimidazolium chloride, 1-butyl-3-methylimidazolium iodide, 1-butyl-3-methylimidazolium bromide, 1-butyl-3-methylimidazolium chloride, 1-pentyl-3-methylimidazolium iodide, 1-pentyl-3-methylimidazolium bromide, 1-pentyl-3-methylimidazolium chloride, 1-hexyl-3-methylimidazolium iodide, 1-hexyl-3-methylimidazolium bromide, 1-hexyl-3-methylimidazolium chloride, 1-heptyl-3-methylimidazolium iodide, 1-heptyl-3-methylimidazolium bromide, 1-heptyl-3-methylimidazolium chloride, 1-octyl-3-methylimidazolium iodide, 1-octyl-3-methylimidazolium bromide, 1-octyl-3-methylimidazolium chloride, 1-nonyl-3-methylimidazolium iodide, 1-nonyl-3-methylimidazolium bromide, 1-nonyl-3-methylimidazolium chloride, 1-decyl-3-methylimidazolium iodide, 1-decyl-3-methylimidazolium bromide, 1-decyl-3-methylimidazolium chloride, 1-undecyl-3-methylimidazolium iodide, 1-undecyl-3-methylimidazolium bromide, 1-undecyl-3-methylimidazolium chloride, 1-dodecyl-3-methylimidazolium iodide, 1-dodecyl-3-methylimidazolium bromide, 1-dodecyl-3-methylimidazolium chloride, 1-tetradecyl-3-methylimidazolium iodide, 1-tetradecyl-3-methylimidazolium bromide, 1-tetradecyl-3-methylimidazolium chloride, 1-hexadecyl-3-methylimidazolium iodide, 1-hexadecyl-3-methylimidazolium bromide, 1-hexadecyl-3-methylimidazolium chloride, 1-octadecyl-3-methylimidazolium iodide, 1-octadecyl-3-methylimidazolium bromide, 1-octadecyl-3-methylimidazolium chloride, 2,3,5-triphenyltetrazolium iodide, 2,3,5-triphenyltetrazolium bromide, 2,3,5-triphenyltetrazolium chloride, 2,3,5-tritolyltetrazolium iodide, 2,3,5-tritolyltetrazolium bromide, 2,3,5-tritolyltetrazolium chloride, tetramethylarsonium iodide, tetramethylarsonium bromide, tetramethylarsonium chloride, tetraethylarsonium iodide, tetraethylarsonium bromide, tetraethylarsonium chloride, tetrapropylarsonium iodide, tetrapropylarsonium bromide, tetrapropylarsonium chloride, tetrabutylarsonium iodide, tetrabutylarsonium bromide, tetrabutylarsonium chloride, tetrapentylarsonium iodide, tetrapentylarsonium bromide, tetrapentylarsonium chloride, tetrahexylarsonium iodide, tetrahexylarsonium bromide, tetrahexylarsonium chloride, tetraphenylarzonium iodide, tetraphenylarzonium bromide, tetraphenylarzonium chloride, tetrapentylarsonium iodide, tetrapentylarsonium bromide, tetrapentylarsonium chloride, tetratolylarsonium iodide, tetratolylarsonium bromide, tetratolylarsonium chloride, methyltriphenylarsonium iodide, methyltriphenylarsonium bromide, methyltriphenylarsonium chloride, ethyltriphenylarsonium iodide, ethyltriphenylarsonium bromide, ethyltriphenylarsonium chloride, propyltriphenylarsonium iodide, propyltriphenylarsonium bromide, propyltriphenylarsonium chloride, butyltriphenylarsonium iodide, butyltriphenylarsonium bromide, butyltriphenylarsonium chloride, pentyltriphenylarsonium iodide, pentyltriphenylarsonium bromide, pentyltriphenylarsonium chloride, hexyltriphenylarsonium iodide, hexyltriphenylarsonium bromide, hexyltriphenylarsonium chloride, benzyltriphenylarsonium iodide, benzyltriphenylarsonium bromide, and benzyltriphenylarsonium chloride.

The alkyl group in all the above-mentioned cases is not limited to an n-form but may be an iso-, sec-, tert- or cyclo-form or may by any other branched form. Not limited to those onium salts as above, the ionic substance may further include cyclic structures where plural substituents bond to each other, and any others having an unsaturated bond or a hetero element.

It is not always necessary to make both the onium salt and the substrate initially coexist in the system in the initial stage of the reaction. Any one or more of them may be produced in the reactor where they are reacted. Concretely, a substance that contains a hydroxide or a carbonate of the onium salt may be mixed with an acid that contains a chloride ion, a bromide ion or an iodide ion; or a starting organic amine, organic phosphine, organic arsine or organic antimony may be reacted with an alkyl halide, an aryl halide or a vinyl halide, thereby producing the intended substance in the reaction system.

The above onium salt may be combined with any other onium salt, salt or metal complex in the reaction system. In particular, a bromide or a chloride is preferably added to the system to attain the same effect as that of ion-exchange reaction.

The inorganic solid substance in the second embodiment may be the same as that in the first embodiment.

The ratio of the Group 15 element-containing ionic substance to the inorganic solid substance in the first and second embodiments may be arbitrary, but is preferably such that the Group 15 element-containing ionic substance is contained in an amount of from 0.001 to 1000 times the weight of the inorganic solid substance.

The advantages of the second embodiment that uses a mixed catalyst system of a Group 15 element-containing ionic substance and an inorganic solid substance are that the catalyst activity is high and the reaction is promoted and that the catalyst recovery after the reaction is easy. In particular, silica efficiently adsorbs the onium salt in the cyclic carbonate which is a product and precipitates, and therefore a major part of the catalyst may be recovered on silica only when the product after the reaction is cooled to around room temperature or lower, and therefore the purification including distillation of the product is easy.

The catalyst system of the second embodiment may well act merely by mixing the two substances in a reactor, but the Group 15 element-containing ionic substance (onium salt) may be previously uniformly dispersed. In order to do so, it is effective that an inorganic solid substance is dipped in a solution of an onium salt dissolved in a suitable organic solvent, preferably any of ketones, alcohols, esters such as ethylene carbonate, propylene carbonate, amides such as dimethylacetamide, dimethylformamide, N-methyloxazolidinone, N,N-dimethylpyrrolidinone or the like having a boiling point not higher than 100° C.; or a similar onium salt solution in an organic solvent is poured into a column filled with an inorganic solid substance so as to be infiltrated into the substance. The onium salt-containing, inorganic solid substance may be washed with a solvent having a low boiling point such as methanol, acetone, diethyl ether, and then dried under normal pressure or reduced pressure, or dried at a low temperature under reduced pressure, and the catalyst is thus prepared. In preparing a dipped catalyst similar to the above, it is not always necessary to use an onium salt as the starting material. Apart from it, an inorganic substance may be dipped in an organic solvent that contains a base such as a tetraalkylammonium hydroxide and an acid such as hydrogen halide along with water to produce a similar substance in the system, and the catalyst may be thus prepared. In addition, a phosphine and an alkyl halide may be mixed directly together or in a suitable solvent to form an onium salt in the system similarly to the above, and an inorganic solid substance may be dipped in the resulting solution whereby a catalyst having nearly the same properties may be prepared. The dipping treatment for catalyst preparation is not always necessary in order that the catalyst could exhibit its activity, but in short time reaction, the pretreatment of the catalyst may be often effective for shortening the reaction time. The thus-prepared catalyst may be mixed with any other solid and/or any other onium salt-containing solid. In its use, the thus-prepared catalyst may be mixed with any other solid such as metal polymer so as to be fixed on it. Any other organic solvent may be added to the reaction system. The examples of the organic solvent include aliphatic and aromatic organic solvents, and hetero atom-containing organic solvents, more precisely alcohols, ethers, esters, amides, tertiary amines, pyridines, sulfides, and phosphines. Concretely, those emplyable are pentane, hexane, heptane, benzene, toluene, methanol, ethanol, diethyl ether, methyl tert-butyl ether, tetrahydrofuran, dioxane, acetone, methyl ethyl ketone, ethyl acetate, ethylene carbonate, propylene carbonate, dimethylformamide, dimethylacetamide, N,N′-dimethylpyridazolinone, pyridine, triethylamine, dibutyl sulfide, and tributyl phosphine.

In the catalyst system of the second embodiment, any further solid may be mixed or may be bonded to it. Examples of the solid include silica, alumina, zeolite, silicon carbide, clay minerals (montmorillonite), silica-alumina, zirconia, and organic polymer, to which, however, the invention should not be limited.

The reaction mode in the invention that uses the above-mentioned catalyst may be any ordinary one such as a stirring system or a fixed bed system. The reaction may be attained in any method of a batch process, a semibatch process or a continuous flow reaction process.

The batch process is, for example, as follows. An epoxide and a catalyst are fed into an autoclave equipped with a stirrer, which is then filled with carbon dioxide and sealed up. Next, the autoclave is heated up to a predetermined temperature with stirring the contents thereof, and then further filled with carbon dioxide to thereby control the inner pressure thereof at a predetermined level. With that, this is reacted for a predetermined period of time, and the produced cyclic carbonate is separated according to a desired method.

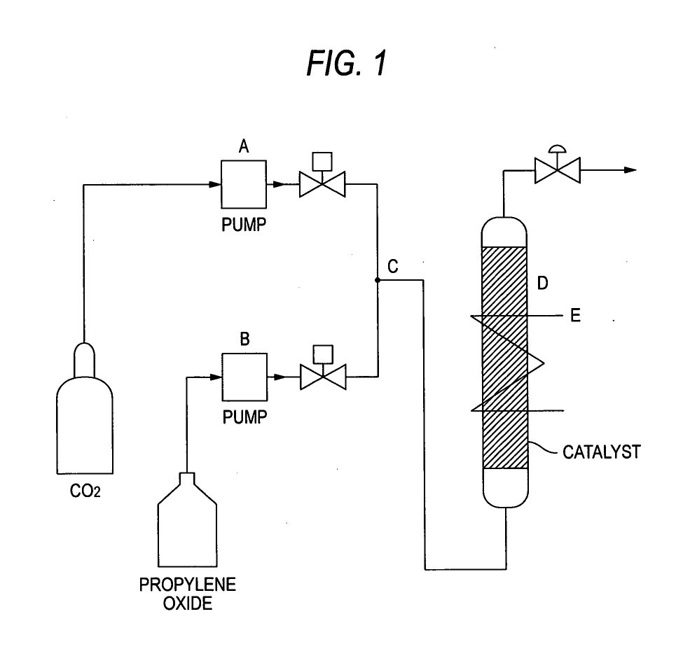

The flow reaction process is as follows, for example, as shown in FIG. 1. Using a flow reaction system (FIG. 1) comprising high-pressure fluid transport pumps (A, B), a fluid mixer (C), a column reactor (D), a pressure controller (E) and a temperature controller (F), for example, propylene carbonate and super-critical carbon dioxide are mixed, then heated in the column reactor (D) filled with a catalyst, and continuously reacted therein. A substance that could be a solvent except the starting materials, propylene oxide and carbon dioxide may be introduced into the reactor along with the starting materials. Concretely, examples of the solvent usable in this case include aliphatic or aromatic organic solvents, and hetero atom-containing organic solvents. More precisely, they are alcohols; ethers, esters, amides, tertiary amines, pyridines, sulfides, and phosphines; and concretely pentane, hexane, heptane, benzene, toluene, methanol, ethanol, diethyl ether, methyl tert-butyl ether, tetrahydrofuran, dioxane, acetone, methyl ethyl ketone, ethyl acetate, ethylene carbonate, propylene carbonate, dimethylformamide, dimethylacetamide, N-methylpyridazine, N,N′-dimethylpyridazolinone, pyridine, triethylamine, dibutyl sulfide, and tributyl phosphine.

In carrying out the invention, the reaction temperature is not specifically defined but is preferably from room temperature to 300° C., more preferably from 50 to 250° C. Not also specifically defined, the reaction pressure may be determined depending on the production cost of the pressure device to be used for the reaction, but is preferably from 0.1 to 200 MPa, more preferably from 0.1 to 25 MPa.

The amount of the ionic substance in the catalyst may vary depending on various conditions including the shape of the reactor used, the type of the starting epoxide, the reaction temperature, the reaction pressure and the desired productivity. For example, when the invention is carried out by the use of a batch-type reactor, then the amount of the catalyst may be from 1/1,000,000 to 10000, preferably from 1/100,000 to 1000, more preferably from 1/10,000 to 100, in terms of the ratio by weight thereof to the starting epoxide.

Not specifically defined in point of the morphology thereof, the catalyst for use in the invention may be generally in the form of fine powder, thin films, or spherical or columnar particles having a mean particle size of about from 0.1 to 10 mm. The catalyst does not require any specific pretreatment, but before used for reaction, it may be processed at room temperature to 120° C., preferably at 50 to 100° C., with degassing in vacuum, or in an inert gas atmosphere of helium, argon, nitrogen or carbon dioxide, or in air, whereby the yield of the cyclic carbon to be produced with it may be increased.

### EXAMPLES

The invention is described in more detail with reference to Examples, which, however, are not intended to restrict the scope of the invention.

### Preparation of Surface Catalyst

### Preparation of Catalyst Through Substitution Reaction

### Example 1

Silica surface-modified with a phosphonium salt was prepared according to the following method: 7.00 g of SiO₂—C₃H₆Cl (manufactured by Aldrich, 3-chloropropyl functional group-having silica gel; amount of functional group per unit weight, 0.71 mmol/g) was suspended in 50 ml of toluene in argon, and with gradually stirring it in a 200-ml three-neck flask equipped with a stirring blade, 3.00 g of tributyl phosphine was added thereto. In an argon atmosphere, the suspension was reacted at 110° C. for 1 week, still kept stirred. The liquid was filtrated away from the suspension after the reaction, and the resulting solid was washed with methanol, acetone and ether in that order, then dried with air, and further dried in a vacuum of 1 mm or less at room temperature for 6 hours. This is used as a catalyst directly as it is. The above reaction may be schematically expressed by the following chemical reaction (7). As a result of elementary analysis thereof the product contained 0.23 mmol/g of P and 0.7 mmol/g of Cl.

### Example 2

As in the following chemical formula 8, silica gel surface-modified with tributylphosphonium bromide, SiO₂—C₃H₆PBu₃Br was obtained according to the same process as in the above section but starting from 3-bromopropyl functional group-having silica gel SiO₂—C₃H₆Br (amount of functional group per unit weight, 1.43 mmol/g). The data of elementary analysis were 0.48 mmol/g of P and 0.85 mmol/g of Br.

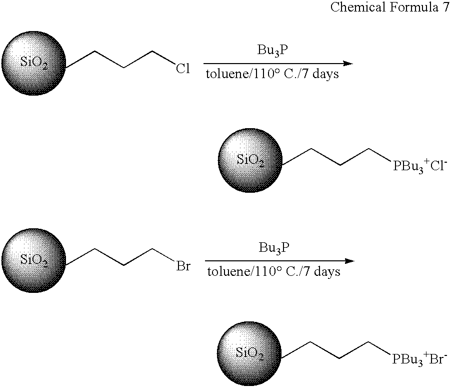

### Preparation of Catalyst Through Ion-Exchange Reaction

### Example 3

Silica gel surface-modified with tributylphosphonium chloride described in Example 1 was converted into a bromide through ion-exchange reaction. Concretely, a solution was prepared by dissolving sodium bromide in from 50 ml to 3000 ml, per gram of SiO₂—C₃H₆PBu₃Cl, of methanol, in an amount of from 5 times to 100 times the theoretical exchange capacity amount thereof (0.7 mmol per gram), and this was gradually applied over the catalyst particles filled in a column or on a filter. After thus treated, the catalyst was washed with methanol, then washed acetone and ethanol in that order, dried with air, transferred into a Schlenk tube, and dried in vacuum at room temperature to 100° C. to obtain SiO₂—C₃H₆PBu₃Br. The data of elementary analysis were 0.4 mmol/g of Cl, 0.36 mmol/g of Br and 0.32 mmol/g of P.

### Example 4

Silica gel surface-modified with tributylphosphonium chloride shown in Example 2 was converted into an iodide through ion-exchange reaction in the same manner as in Example 3. Concretely, SiO₂—C₃H₆PBu₃I was obtained according to the same process as in Example 3 but using potassium iodide in place of sodium bromide for SiO₂—C₃H₆PBu₃Cl. The data of elementary analysis were 0.32 mmol/g of P, 0.47 mmol/g of Cl, and 0.26 mmol/g of P.

### Example 5

SiO₂—C₃H₆PEt₃Cl was obtained in the same manner as in Example 1 but using triethyl phosphine in place of tributyl phosphine. This was further processed in the same manner as in Example 3 to give SiO₂—C₃H₆PEt₃Cl.

### Example 6

SiO₂—C₃H₆PPh₃Br was obtained in the same manner as in Example 2 but using triphenyl phosphine in place of tributyl phosphine. As a result of elementary analysis thereof, this contained 0.31 mmol/g of P and 0.89 mmol/g of Br.

### Example 7

SiO₂—C₃H₆NC₅H₅Br was obtained in the same manner as in Example 2, for which, however, pyridine was used in place of tributyl phosphine and the reaction temperature was 50° C. As a result of elementary analysis thereof, this contained 7.58 mmol/g of C, 17.9 mmol/g of H, 0.64 mmol/g of N and 1.08 mmol/g of Br.

### Example 8

SiO₂—C₃H₆NC₅H₄^{t}C₄H₉Br was obtained in the same manner as in Example 8, for which, however, 4-tert-butylpyridine was used in place of pyridine and the reaction temperature was 50° C. As a result of elementary analysis thereof, this contained 7.66 mmol/g of C, 16.87 mmol/g of H, 0.39 mmol/g of N and 1.08 mmol/g of Br.

### Example 9

SiO₂—C₃H₆—NMe₃Br can be obtained by reacting a predetermined amount of a commercially-available catalyst, SiO₂—C₃H₆NMe₃(CO₃)_{1/2} (by Aldrich, loading 0.7 mmol/g) surface-modified with trimethylammonium carbonate, with a water-containing methanol solution of the same amount of HBr. Concretely, a methanol solution of HBr containing 10% of water was gradually added to SiO₂—C₃H₆NMe₃(CO₃)_{1/2} suspended in ethanol to neutralize it. While the solution was monitored for its pH, the HBr-ethanol solution was added to it until its pH could reach 4 or less whereby the neutralization of the solution was confirmed. After that, the catalyst was collected through filtration, washed with acetone and ether, dried with air, further dried in vacuum at from room temperature to 100° C. to obtain SiO₂—C₃H₆—NMe₃Br. The data of elementary analysis were 4.25 mmol/g of C, 14.9 mmol/g of H, 0.60 mmol/g of N, and 0.58 mmol/g of Br.

### Example 10

Through the same neutralization as in Example 10 with starting from the same materials as therein but using HI in place of HBr, SiO₂—C₃H₆—NMe₃I was obtained.

### Example 11

SiO₂—C₆H₄CH₂PBu₃Cl was obtained, starting from silica gel surface modified with phenylmethylene-chloride group, SiO₂—C₆H₄CH₂Cl (loading, 1.3 mmol/g) and reacting it with tributyl phosphine in the same manner as in Example 1. The data of elementary analysis were 0.46 mmol/g of P, and 1.0 mmol/g of Cl.

### Example 12

SiO₂—C₆H₄CH₂PBu₃Br was obtained, starting from SiO₂—C₆H₄CH₂PBu₃Cl obtained in Example 11 and processing it with a sodium bromide-methanol solution for ion-exchange reaction in the same manner as in Example 3. The data of elementary analysis were 0.40 mmol/g of P, 0.41 mmol/g of Cl, and 0.48 mmol/g of Br.

### Evaluation of Catalyst Activity

### Example 13

Reaction for propylene carbonate synthesis was carried out according to the following method: Propylene oxide (57.2 mmol) and 800 mg of the catalyst SiO₂—C₃H₆PBu₃Cl prepared in Example 1, and as an internal standard, 50 mg of adamantane were put into a 20-mL autoclave equipped with a stirrer put therein, in an argon atmosphere, then filled with carbon dioxide and sealed up. Next, with stirring them, the contents of the autoclave were heated up to 100° C., further filled with carbon dioxide, and reacted for 8 hours while the inner pressure was kept at 14 MPa. After cooled, the remaining carbon dioxide was discharged out, and the reaction mixture was analyzed through gas chromatography. The result is shown in Table 1.

### Example 14

Propylene carbonate was produced in the same manner as in Example 13, for which, however, SiO₂—C₃H₆PBu₃Br produced in Example 2 was used as the catalyst and the reaction time was 4 hours. The result is shown in Table 1.

### Example 15

Propylene carbonate was produced in the same manner as in Example 13, for which, however, the CO₂ pressure was 10 MPa and the reaction temperature was 150° C. The result is shown in Table 1.

### Example 16

Propylene carbonate was produced in the same manner as in Example 13, for which, however, the CO₂ pressure was 0.95 MPa and the reaction temperature was 100° C. The result is shown in Table 1.

### Example 17

Propylene carbonate was produced in the same manner as in Example 13, for which, however, SiO₂—C₃H₆PBu₃Br prepared according to the ion-exchange process in Example 3 was used as the catalyst, the reaction time was 1 hour, and the reaction was effected at 100° C. under 10 MPa. The result is shown in Table 1.

### Example 18

Propylene carbonate was produced in the same manner as in Example 17, for which, however, SiO₂—C₃H₆PBu₃I prepared according to the ion-exchange process in Example 4 was used as the catalyst. The result is shown in Table 1.

### Example 19

Propylene carbonate was produced under the same condition as in Example 17, for which, however, SiO₂—C₃H₆PEt₃Br prepared with triethyl phosphine in Example 5 was used as the catalyst. The result is shown in Table 1.

### Example 20

Propylene carbonate was produced under the same condition as in Example 17, for which, however, SiO₂—C₃H₆PPh₃Br prepared with triphenyl phosphine in Example 6 was used as the catalyst. The result is shown in Table 1.

### Example 21

Propylene carbonate was produced under the same condition as in Example 17, for which, however, SiO₂—C₃H₆NC₅H₅Br produced in Example 7 was used as the catalyst. The result is shown in Table 1.

### Example 22

Propylene carbonate was produced under the same condition as in Example 17, for which, however, SiO₂—C₃H₆NC₅H₅(4-tert-C₄H₉)Br produced in Example 8 was used as the catalyst. The result is shown in Table 1.

### Example 23

Propylene carbonate was produced under the same condition as in Example 17, for which, however, a commercially-available catalyst, SiO₂—C₃H₆NMe₃(CO₃)_{1/2} (by Aldrich) was used as the catalyst and the reaction temperature was 180° C. The result is shown in Table 1.

### Example 24

Propylene carbonate was produced in the same manner as in Example 17, for which, however, the catalyst SiO₂—C₂H₆NMe₃Br prepared through neutralization of SiO₂—C₃H₆NMe₃(CO₃)_{1/2} with hydrobromic acid in Example 9 was used. The result is shown in Table 1.

### Example 25

Propylene carbonate was produced in the same manner as in Example 17, for which, however, the catalyst SiO₂—C₂H₆NMe₃I prepared through neutralization of SiO₂—C₃H₆NMe₃(CO₃)_{1/2} with hydroiodic acid in Example 10 was used. The result is shown in Table 1.

### Example 26

Propylene carbonate was produced in the same manner as in Example 17, for which, however, SiO₂—C₆H₄CH₂PBuCl produced in Example 11 was used as the catalyst. The result is shown in Table 1.

### Example 27

Propylene carbonate was produced in the same manner as in Example 17, for which, however, SiO₂—C₆H₄CH₂PBuBr prepared according to the ion-exchange process with SiO₂—C₆H₄CH₂PBuCl in Example 12 was used as the catalyst. The result is shown in Table 1.

### Comparative Examples

### Comparative Example 1

Reaction of propylene carbonate synthesis was carried out in the same manner as in Example 1, for which however, commercially-available PBu₄Br was used. The result is shown in Table 1.

### Comparative Example 2

Reaction of propylene carbonate synthesis was carried out in the same manner as in Example 1, for which, however, commercially-available surface-modified silica gel, SiO₂—C₃H₆Br was used. The result is shown in Table 1.

### Comparative Example 3

A commercially-available bead-like polystyrene resin (ArgoPore-Cl) represented by PS—C₆H₄CH₂Cl in which, however, a part of the phenyl group has a 4-chloromethyl group, was reacted with tributyl phosphine (PBu₃) in the same manner as in Example 1, thereby producing a partially phosphonium-ionized polystyrene resin PS—C₆H₄CH₂PBu₃Cl. This was processed for ion-exchange reaction with sodium bromide in the same manner as in Example 3, and converted into PS—C₆H₄CH₂PBu₃Br. Using the thus-obtained resin as a catalyst, propylene carbonate was produced in the same manner as in Example 13. The result is shown in Table 1.

### Comparative Example 4

PS—C₆H₄PBu₃Cl produced in Comparative Example 3 was processed for ion-exchange reaction with potassium iodide in the same manner as in Example 4, thereby converting it into PS—C₆H₄CH₂PBu₃I. Using the thus-obtained resin as a catalyst, propylene carbonate was produced in the same manner as in Example 13. The result is shown in Table 1.

### Comparative Example 5

A commercially-available bead-like polystyrene resin (ArgoGel) represented by PS—C₆H₄CH(CH₂(OC₂H₄)ₙCl)₂ in which, however, a part of the phenyl group is modified with a methyl group having two chloroethyl groups bonding to each other via a polyethylene glycol chain therebetween, at the 4-position thereof was reacted with tributyl phosphine in the same manner as in Example 1, thereby producing a polystyrene resin partially having a phosphonium ion via polyethylene glycol, PS—C₆H₄CH(CH₂(OC₂H₄)ₙPBu₃Cl)₂. The functional conversion presumed from the data of elementary analysis, P of 0.8%, Cl of 1.4% and C of 61.9%, was 60%. Using the thus-obtained resin as a catalyst, propylene carbonate was produced in the same manner as in Example 13. The result is shown in Table 1.

### Continuous Flow Reaction

### Example 28

This is an experiment for continuously producing a product. Propylene carbonate and super-critical carbon dioxide were mixed, using the reaction system shown in FIG. 1, and then heated in a 20-mL reaction tube filled with the catalyst SiO₂—C₃H₆PBu₃Br described in Example 2. The product was trapped with DMF in which a standard substance had been previously dissolved, for a predetermined period of time, and the sample was analyzed for its composition through gas chromatography. The reaction was continued for 24 hours, and sampled and analyzed in the same manner. The reaction temperature was 90° C. and the pressure was 10 MPa. The result is shown in Table 2.

### Comparative Example 6

Similarly this is an experiment for continuously producing a product. PS—CH₄CH₂PBu₃Br prepared according to the method of Example 4 was filled in the reaction time in the same reaction system as in Example 28. The product was analyzed in the same manner as in Example 28. However, since the yield was too low even at a reaction temperature of 120° C., the temperature was elevated up to 140° C. after 4 hours and the pressure was kept at 10 MPa. The result is shown in Table 2.

TABLE 1

| | Catalyst | Amount of Catalyst | Time | Conversion | Selectivity | Yield |
|---|---|---|---|---|---|---|
| Example | (Temp. Pressure) | (mg) | (hr) | (%) | (%) | (%) |
| Ex. 13 | SiO₂—C₃H₆PBu₃Cl | 800 | 8 | 82 | 100 | 82 |
| | (100° C., 14 MPa) | | | | | |
| Ex. 14 | SiO₂—C₃H₆PBu₃Br | 400 | 4 | 97 | 100 | 97 |
| | (100° C., 14 MPa) | | | | | |
| Ex. 15 | SiO₂—C₃H₆PBu₃Br | 400 | 1 | 99 | 100 | 99 |
| | (150° C., 10 MPa) | | | | | |
| Ex. 16 | SiO₂—C₃H₆PBu₃Br | 400 | 4 | 84 | 100 | 84 |
| | (100° C., 0.95 MPa) | | | | | |
| Ex. 17 | SiO₂—C₃H₆PBu₃Br | 800 | 1 | 92 | 100 | 92 |
| | (100° C., 10 MPa) | | | | | |
| Ex. 18 | SiO₂—C₃H₆PBu₃I | 800 | 1 | 100 | 100 | 100 |
| | (100° C., 10 MPa) | | | | | |
| Ex. 19 | SiO₂—C₃H₆PEt₃Br | 400 | 1 | 98 | 100 | 98 |
| | (100° C., 10 MPa) | | | | | |
| Ex. 20 | SiO₂—C₃H₆PPh₃Br | 400 | 1 | 79 | 100 | 79 |
| | (100° C., 10 MPa) | | | | | |
| Ex. 21 | SiO₂—C₃H₆PyBr | 400 | 1 | 41 | 100 | 41 |
| | (100° C., 10 MPa) | | | | | |
| Ex. 22 | SiO₂—C₃H₆(4-^{t}BuPy)Br | 400 | 1 | 44 | 100 | 44 |
| | (100° C., 10 MPa) | | | | | |
| Ex. 23 | SiO₂—C₃H₆NMe₃(CO₃)_{1/2} | 830 | 1 | 53 | 96 | 51 |
| | (200° C., 10 MPa) | | | | | |
| Ex. 24 | SiO₂—C₃H₆NMe₃Br | 830 | 1 | 87 | 100 | 87 |
| | (100° C., 10 MPa) | | | | | |
| Ex. 25 | SiO₂—C₃H₆—NMe₃I | 830 | 1 | 83 | 100 | 83 |
| | (100° C., 10 MPa) | | | | | |
| Ex. 26 | SiO₂—C₆H₄CH₂PBu₃Cl | 440 | 8 | 88 | 100 | 88 |
| | (100° C., 10 MPa) | | | | | |
| Ex. 27 | SiO₂—C₆H₄CH₂PBu₃Br | 440 | 1 | 37 | 100 | 37 |
| | (100° C., 10 MPa) | | | | | |
| Comp. Ex. 1 | PBu₄Br | 192 | 1 | 4 | 100 | 4 |
| | (100° C., 10 MPa) | | | | | |
| Comp. Ex. 2 | SiO₂—C₃H₆Br | 400 | 1 | 0 | 0 | 0 |
| | (100° C., 10 MPa) | | | | | |
| Comp. Ex. 3 | PS—C₆H₄CH₂PBu₃Br | 400 | 1 | 10 | 100 | 10 |
| | (100° C., 10 MPa) | | | | | |
| Comp. Ex. 4 | PS—C₆H₄CH₂PBu₃I | 580 | 1 | 7 | 100 | 7 |
| | (100° C., 10 MPa) | | | | | |
| Comp. Ex. 5 | PS—C₆H₄CH(CH₂(OC₂H₄)ₙPBu₃Cl)₂ | 400 | 8 | 2 | 100 | 2 |
| | (100° C., 14 MPa) | | | | | |

In the Table 1, SiO₂ is silica gel; PS is polystyrene. Bu is an n-butyl group; ^{t}Bu is a tert-butyl group; Me is a methyl group; Et is an ethyl group; Ph is a phenyl group; Bz is a benzyl group; C₆H₄ is a p-phenylene group; Py is a pyridinium group bonding to a linker via N; and (4-^{t}BuPy) is a pyridinium group bonding to a linker via N and substituted at the 4-position.

Reaction Condition:

The amount of the catalyst was 0.57 mmol corresponding to 1 mol % of the substrate, propylene oxide (4 mL, 57.2 mmol) on the presumption that the functional group conversion could be 100%. The yield was determined through gas chromatography using adamantane as the standard substance.

TABLE 2
Results of Sampling in Continuous Flow Reaction Experiment
(Example 28, Comparative Example 6)

| | Temperature | Pressure | Time | Yield | Selectivity |
|---|---|---|---|---|---|
| SiO₂—C₃H₆PBu₃Br | 90° C. | 10 MPa | 2 h | 99% | 99.5% |
| (Example 28) | 90° C. | 10 MPa | 24 h | 98% | 100% |
| PS—C₆H₄CH₂PBu₃Br | 120° C. | 10 MPa | 2 h | 2% | 100% |
| (Comp. Ex. 6) | 140° C. | 10 MPa | 24 h | 38% | 100% |

The reactor can be heated externally, and has a volume of 20 ml. In the sample in Comparative Example 6, a trace of tributylphosphine oxide was detected.

### Mixed Catalyst System of Onium Salt and Silica

### Example 29

0.57 mmol of commercially-available tetrabutylphosphonium bromide, 500 mg of silica gel (Kanto Silica Gel 60 N, 100-200 mesh), and, as an internal standard, 50 mg of adamantane were put into a 20-mL autoclave equipped with a stirrer, a pressure gauge and a needle valve, in argon. Using a syringe, 4 ml of propylene oxide was introduced to it, and sealed up. Via the needle valve, liquid CO₂ at room temperature was filled in the autoclave. This was sealed up, and heated in an oil bath set at a predetermined temperature for about 5 hours with stirring. Further, high-pressure CO₂ was introduced into it via the valve under pressure so that it could have a predetermined pressure, and then this was continuously heated to promote the reaction. When the pressure lowered extremely during the reaction, CO₂ was further added to it via the valve. The reaction was continued for a predetermined period of time while the inner pressure was kept almost constant. After the reaction, the reactor was depressurized whereupon the discharged gas was led through a DMF trap by which a part of the starting material propylene oxide and the product propylene carbonate remaining in the vapor phase were trapped as completely as possible. The whole of the DMF solution combined with the reaction solution was well uniformly mixed and then filtered. The silica gel thus separated through filtration was again washed with DMF. The mixture was combined with the wash and again uniformly mixed, and this was analyzed through gas chromatography. The yield was computed from the molar amount of the produced propylene carbonate, and the selectivity was computed in consideration of the amount of the side product. The result is shown in Table 3.

Dada Analysis

Regarding the reaction at 100% selectivity (in which any side product except the main product is not detected at all), it is known that the starting material is converted 100% into a product through long-term reaction and the reaction goes on as a first-order reaction relative to the staring material. Accordingly, the time-dependent change in the amount of the product follows a formula, 1−Exp(−t/τ) based on the total amount of 1. In this formula, t indicates the reaction time, and its unit is “minute” for calculation. τ indicates the time constant of the reaction; and its reciprocal number, 1/τ=k′ is the apparent first-order reaction rate constant. In first-order reaction rate normalized to the catalyst used, the value k obtained by dividing this k′ by the molar fraction of the catalyst to the substrate shall be a constant value. When the molar fraction (yield) of the product at a time t is represented by y(t), then y(t)=1−Exp(−t/τ), and therefore τ=−t/ln(1−y(t)). Further, k′=−ln(1−y(t))/t, and the rate constant may be thus obtained. The equation, k=k′/[mol of catalyst]/[mol of propylene oxide] shall be ideally a constant value irrespective of the amount of the catalyst used, and therefore this is effective as a parameter for objectively indicating the catalyst potency. In case where a reaction goes on in accordance with an exponential function, one molecule of the catalyst corresponds to the number of the molecule of the product to be produced per a unit time in the initial stage of the reaction, and in general, this is equal to TOF (turn-over frequency) of the initial rate. In Table 1, the reaction rate constant k is determined according to this formula, and the potency per mol of the catalyst can be compared under the condition.

### Examples 30 to 70

In place of tetrabutylphosphonium chloride in Example 29, used were commercially-available tetrabutylphosphonium bromide (Examples 30, 31), tetrabutylphosphonium iodide (Example 32), tetraphenylphosphonium bromide (Example 33), benzyltributylphosphonium bromide (Example 34), benzyltriphenylphosphonium bromide (Example 35), butyltriphenylphosphonium bromide (Example 36, Example 37), tetramethylammonium bromide (Example 38), ethyltrimethylammonium iodide (Example 39), triethylmethylammonium bromide (Example 40), tetraethylammonium chloride (Example 41), tetraethylammonium bromide (Examples 42 to 44), tetraethylammonium iodide (Example 45), tetrabutylammonium bromide (Example 46), tetraheptylammonium bromide (Example 47), hexadecyltrimethylammonium bromide (Example 48), dimethyldioctadecylammonium bromide (Example 49), trimethylphenylammonium iodide (Example 50), benzyltriethylammonium bromide (Example 51), acetylcholine bromide (Example 52), butylmethylimidazolium bromide (Example 53), methyloctylimidazolium chloride (Example 54), methylpyridinium chloride Example 55), ethylpyridinium bromide (Example 56), hexadecylpyridinium bromide (Example 57), 2,3,5-triphenyltetrazolium iodide (Example 58), tetraphenylarsonium chloride (Example 59), tetramethylammonium nitroxide (Example 60), tetramethylammonium sulfate (Example 61), tetramethylammonium hydrosulfate (Example 62), tetramethylammonium acetate (Example 63), tetraethylammonium tosylate (Example 64), tetraethylammonium trifluoroacetate (Example 65), tetrabutylammonium cyanide (Example 66), tetrabutylammonium dihydrophosphate (Example 68), tetraethylammonium tetrafluoroborate (Example 69), or pyridinium trimethylenesulfone hydroxide inner salt (Example 70), and the same experiment was carried out except that the reaction temperature was changed or EC (ethylene carbonate) was used as a solvent for salt in some cases, and the data were analyzed in the same manner as above. The results are shown in Table 3.

### Comparative Examples 7 to 48

The same reaction as in Examples 29 to 74 was carried out with no addition of silica gel. Concretely, using tetrabutylphosphonium chloride (Comparative Example 7), tetrabutylphosphonium chloride (Comparative Example 8), tetraphenylphosphonium bromide (Comparative Examples 9, 10), tetrabutylphosphonium iodide (Comparative Example 11), tetraphenylphosphonium bromide (Comparative Example 12), benzyltributylphosphonium bromide (Comparative Example 13), benzyltriphenylphosphonium bromide (Comparative Example 14), butyltriphenylphosphonium bromide (Comparative Example 15, Comparative Example 16), tetramethylammonium bromide (Comparative Example 17), ethyltrimethylammonium iodide (Comparative Example 18), triethylmethylammonium bromide (Comparative Example 19), tetraethylammonium chloride (Comparative Example 20), tetraethylammonium bromide (Comparative Examples 21 to 23), tetraethylammonium iodide (Comparative Example 24), tetrabutylammonium bromide (Comparative Example 25), tetraheptylammonium bromide (Comparative Example 26), hexadecyltrimethylammonium bromide (Comparative Example 27), dimethyldioctadecylammonium bromide (Comparative Example 28), trimethylphenylammonium iodide (Comparative Example 29), benzyltriethylammonium bromide (Comparative Example 30), acetylcholine bromide (Comparative Example 31), butylmethylimidazolium bromide (Comparative Example 32), methyloctylimidazolium chloride (Comparative Example 33), methylpyridinium chloride (Comparative Example 34), ethylpyridinium bromide (Comparative Example 35), hexadecylpyridinium bromide (Comparative Example 36), 2,3,5-triphenyltetrazolium iodide (Comparative Example 37), tetraphenylarsonium chloride (Comparative Example 38), tetramethylammonium nitroxide (Comparative Example 39), tetramethylammonium sulfate (Comparative Example 40), tetramethylammonium hydrosulfate (Comparative Example 41), tetramethylammonium acetate (Comparative Example 42), tetraethylammonium tosylate (Comparative Example 43), tetraethylammonium trifluoroacetate (Comparative Example 44), tetrabutylammonium cyanide (Comparative Example 45), tetrabutylammonium dihydrophosphate (Comparative Example 46), tetraethylammonium tetrafluoroborate (Comparative Example 47), or pyridinetrimethylene sulfoxide (Comparative Example 48), the experiment corresponding to that in Examples was carried out, and the data were analyzed in the same manner as above. The results are shown in Table 3.

### Mixed Catalyst System of Onium Salt and Other Metal Oxide

### Examples 71 to 74

According to the same method as in Example 29, in which, however, 500 g of an inorganic metal oxide was added in place of 500 mg of silica, the potency of each catalyst was evaluated in the presence of tetraethylammonium bromide. Except silica, concretely, alumina (Example 71), magnesia (Example 60), zinc oxide (Example 72), zirconia (Example 73) and drying silica gel with blue indicator (Example 74) were tested for their activity and selectivity.

### Comparative Examples 49 to 53

According to the same method as in Example 8, in which, however, 500 mg of an inorganic metal salt alone was used in place of tetraethylammonium bromide, the metal oxide catalyst alone was evaluated for its activity. Except silica, concretely, alumina (Comparative Example 49), magnesia (Comparative Example 50), zinc oxide (Comparative Example 51), zirconia (Comparative Example 52) and drying silica gel with blue indicator (Comparative Example 53) were used.

### Comparative Examples 54, 55

According to the same method as in Example 13, reaction was carried out under two conditions, using silica gel alone but not using an onium salt, and the data were analyzed in the same manner as therein. The results are shown in Table 3.

Table 3 confirms the following: In every case, addition of silica resulted in the increase in the catalyst activity by from 2 times to 150 times or more as compared with the corresponding case where an onium salt alone was used as the catalyst. In particular, in the case where the onium salt has a high melting point and has a low solubility, the onium salt not having an apparent activity could be activated. It is known that the difference in the alkyl group alone does not result in any significant difference, and that the anion of I or Br enjoys a remarkable acceleration effect with addition of silica but the effect is generally small when the anion is Cl. Silica alone does not show any catalytic activity at all, and this indicates the synergistic effect of the combination of silica-onium salt. To that effect, the composite catalyst that comprises silica and an onium salt has many industrial characteristics and advantages in that its product selectivity is extremely high, it may significantly improve the reaction speed, its recovery and recycle is easy, it is safe and inexpensive, and its life is long.

TABLE 3

| | | | | | | | | |
|---|---|---|---|---|---|---|---|---|
| | | | Temp. | Pressure | Time | | | |
| Example | Onium Salt | Additive | ° C. | MPa | hr | Selectivity % | Yield % | k(min⁻¹) |

[Onium Halide]

| | | | | | | | | |
|---|---|---|---|---|---|---|---|---|
| Ex. 29 | PBu₄Cl | SiO₂ | 100 | 10 | 1 | 100 | 38 | 0.80 |
| Comp. Ex. 8 | PBu₄Cl | none | 100 | 10 | 1 | 100 | 13 | 0.23 |
| Ex. 30 | PBu₄Br | SiO₂ | 100 | 10 | 1 | 100 | 67 | 1.8 |
| Comp. Ex. 9 | PBu₄Br | none | 100 | 10 | 1 | 100 | 4 | 0.07 |
| Ex. 31 | PBu₄Br | SiO₂ + EC* | 100 | 10 | 1 | 100 | 74 | 2.3 |
| Comp. Ex. 10 | PBu₄Br | EC | 100 | 10 | 1 | 100 | 1.8 | 0.03 |
| Ex. 32 | PBu₄I | SiO₂ | 100 | 10 | 1 | 100 | 85 | 3.2 |
| Comp. Ex. 11 | PBu₄I | none | 100 | 10 | 1 | 100 | 5 | 0.08 |
| Ex. 33 | PPh₄Br | SiO₂ | 100 | 10 | 1 | 100 | 92 | 4.2 |
| Comp. Ex. 12 | PPh₄Br | none | 100 | 10 | 1 | — | 0 | 0 |
| Ex. 34 | PBzBu₃Br | SiO₂ | 100 | 10 | 1 | 100 | 81 | 2.7 |
| Comp. Ex. 13 | PBzBu₃Br | none | 100 | 10 | 1 | 100 | 7 | 0.03 |
| Ex. 35 | PBzPh₃Br | SiO₂ | 100 | 10 | 1 | 100 | 85 | 3.1 |
| Comp. Ex. 14 | PBzPh₃Br | none | 100 | 10 | 1 | 100 | 0.1 | 0.004 |
| Ex. 36 | PBuPh₃Br | SiO₂ | 100 | 10 | 1 | 100 | 83 | 3.3 |
| Comp. Ex. 15 | PBuPh₃Br | none | 100 | 10 | 1 | — | 0 | 0 |
| Ex. 37 | PBuPh₃Br | SiO₂ + EC* | 100 | 10 | 1 | 100 | 86 | 3.3 |
| Comp. Ex. 16 | PBuPh₃Br | EC | 100 | 10 | 1 | 100 | 2 | 0.03 |
| Ex. 38 | NMe₄Br | SiO₂ | 200 | 10 | 1 | 82 | 82 | 2.8 |
| Comp. Ex. 17 | NMe₄Br | none | 200 | 10 | 1 | 90 | 7 | 0.1 |
| Ex. 39 | NEtMe₃I | SiO₂ | 100 | 10 | 1 | 100 | 98 | 6.5 |
| Comp. Ex. 18 | NEtMe₃I | none | 100 | 10 | 1 | — | 0 | 0 |
| Ex. 40 | NEt₃MeBr | SiO₂ | 100 | 10 | 1 | 100 | 97 | 5.8 |
| Comp. Ex. 19 | NEt₃MeBr | none | 100 | 10 | 1 | — | 0 | 0 |
| Ex. 41 | NEt₄Cl•H₂O | SiO₂ | 100 | 10 | 1 | 100 | 27 | 0.53 |
| Comp. Ex. 20 | NEt₄Cl•H₂O | none | 100 | 10 | 1 | 100 | 0 | 0 |
| Ex. 42 | NEt₄Br | SiO₂ | 100 | 10 | 1 | 100 | 89 | 3.7 |
| Comp. Ex. 21 | NEt₄Br | none | 100 | 10 | 1 | — | 0 | 0 |
| Ex. 43 | NEt₄Br | SiO₂ + EC* | 100 | 10 | 1 | 100 | 67 | 1.8 |
| Comp. Ex. 22 | NEt₄Br | EC | 100 | 10 | 1 | 100 | 5.6 | 0.10 |
| Ex. 44 | NEt₄Br | SiO₂ | 100 | 0.95 | 1 | 100 | 54 | 1.3 |
| Comp. Ex. 23 | NEt₄Br | none | 100 | 0.95 | 1 | — | 0 | 0 |
| Ex. 45 | NEt₄I | SiO₂ | 100 | 10 | 1 | 100 | 92 | 4.2 |
| Comp. Ex. 24 | NEt₄I | none | 100 | 10 | 1 | 100 | 0 | 0 |
| Ex. 46 | NⁿBu₄Br | SiO₂ | 100 | 10 | 1 | 100 | 89 | 3.7 |
| Comp. Ex. 25 | NⁿBu₄Br | none | 100 | 10 | 1 | 100 | 5.0 | 0.09 |
| Ex. 47 | NHp₄Br | SiO₂ | 100 | 10 | 1 | 98 | 72 | 2.1 |
| Comp. Ex. 26 | NHp₄Br | none | 100 | 10 | 1 | 100 | 3.4 | 0.06 |
| Ex. 48 | N(ⁿC₁₆)Me₃Br | SiO₂ | 100 | 10 | 1 | 100 | 87 | 3.4 |
| Comp. Ex. 27 | N(ⁿC₁₆)Me₃Br | none | 100 | 10 | 1 | 100 | 0.1 | 0.002 |
| Ex. 49 | N(ⁿC₁₈)₂Me₂Br | SiO₂ | 100 | 10 | 1 | 100 | 16 | 0.04 |
| Comp. Ex. 28 | N(ⁿC₁₈)₂Me₂Br | none | 100 | 10 | 1 | — | 0 | 0 |
| Ex. 50 | NMe₃PhI | SiO₂ | 100 | 10 | 1 | 100 | 87 | 3.4 |
| Comp. Ex. 29 | NMe₃PhI | none | 100 | 10 | 1 | — | 0 | 0 |
| Ex. 51 | NBzEt₃Br | SiO₂ | 100 | 10 | 1 | 100 | 93 | 4.4 |
| Comp. Ex. 30 | NBzEt₃Br | none | 100 | 10 | 1 | — | 0 | 0 |
| Ex. 52 | N(C₂OAc)Me₃Br | SiO₂ | 100 | 10 | 1 | 98 | 95 | 5.0 |
| Comp. Ex. 31 | N(C₂OAc)Me₃Br | none | 100 | 10 | 1 | — | 0 | 0 |
| Ex. 53 | ImBuMeBr | SiO₂ | 100 | 10 | 1 | 100 | 62 | 1.6 |
| Comp. Ex. 32 | ImBuMeBr | none | 100 | 10 | 1 | — | 0 | 0 |
| Ex. 54 | ImⁿC₈MeCl | SiO₂ | 100 | 10 | 1 | 100 | 32 | 0.64 |
| Comp. Ex. 33 | ImⁿC₈MeCl | none | 100 | 10 | 1 | 100 | 16 | 0.30 |
| Ex. 55 | PyMeCl | SiO₂ | 100 | 10 | 1 | 70 | 17 | 0.31 |
| Comp. Ex. 34 | PyMeCl | none | 100 | 10 | 1 | 99 | 0.1 | 0.002 |
| Ex. 56 | PyEtBr | SiO₂ | 100 | 10 | 1 | 97 | 94 | 4.6 |
| Comp. Ex. 35 | PyEtBr | none | 100 | 10 | 1 | 100 | 0.6 | 0.01 |
| Ex. 57 | PyⁿC₁₆Br | SiO₂ | 100 | 10 | 1 | 100 | 94 | 4.6 |
| Comp. Ex. 36 | PyⁿC₁₆Br | none | 100 | 10 | 1 | 100 | 5.0 | 0.09 |
| Ex. 58 | TetPh₃I | SiO₂ | 100 | 10 | 1 | 100 | 95 | 5.0 |
| Comp. Ex. 37 | TetPh₃I | none | 100 | 10 | 1 | — | 0 | 0 |
| Ex. 59 | AsPh₄Cl | SiO₂ | 100 | 10 | 1 | 100 | 52 | 1.2 |
| Comp. Ex. 38 | AsPh₄Cl | none | 100 | 10 | 1 | 100 | 5.0 | 0.10 |

[Salt with Anion except Halide Ion]

| | | | | | | | | |
|---|---|---|---|---|---|---|---|---|
| Ex. 60 | NMe₄NO₃ | SiO₂ + EC* | 180 | 10 | 8 | 90 | 85 | 0.4 |
| Comp. Ex. 39 | NMe₄NO₃ | EC | 180 | 10 | 8 | 95 | 15 | 0.04 |
| Ex. 61 | (NMe₄)₂SO₄ | SiO₂ + EC* | 100 | 10 | 8 | 98 | 30 | 0.08 |
| Comp. Ex. 40 | (NMe₄)₂SO₄ | EC | 100 | 10 | 8 | — | 0 | 0 |
| Ex. 62 | NMe₄(HSO₄) | SiO₂ + EC* | 180 | 10 | 8 | 98 | 25 | 0.05 |
| Comp. Ex. 41 | NMe₄(HSO₄) | EC | 180 | 10 | 8 | 98 | 2 | 0.005 |
| Ex. 63 | NMe₄(OAc) | SiO₂ + EC* | 100 | 10 | 8 | 90 | 39 | 0.1 |
| Comp. Ex. 42 | NMe₄(OAc) | EC | 180 | 10 | 8 | — | 0 | 0 |
| Ex. 64 | NEt₄(OTs) | SiO₂ + EC* | 180 | 10 | 8 | 80 | 60 | 0.2 |
| Comp. Ex. 43 | NEt₄(OTs) | EC | 180 | 10 | 8 | 90 | 1.6 | 0.003 |
| Ex. 65 | NEt₄(OCOCF₃) | SiO₂ + EC* | 180 | 10 | 1 | 95 | 86 | 3.4 |
| Comp. Ex. 44 | NEt₄(OCOCF₃) | EC | 180 | 10 | 1 | 95 | 62 | 1.6 |
| Ex. 66 | NⁿBu₄CN | SiO₂ + EC* | 100 | 10 | 8 | 80 | 43 | 0.12 |
| Comp. Ex. 45 | NⁿBu₄CN | EC | 100 | 10 | 8 | — | 0 | 0 |
| Ex. 67 | NBu₄H₂PO₄ | SiO₂ + EC* | 180 | 10 | 1 | 95 | 42 | 0.9 |
| Comp. Ex. 46 | NBu₄H₂PO₄ | EC | 180 | 10 | 1 | 95 | 18 | 0.3 |
| Ex. 68 | NMe₄BF₄ | SiO₂ | 180 | 10 | 8 | 95 | 34 | 0.09 |
| Comp. Ex. 47 | NMe₄BF₄ | SiO₂ | 180 | 10 | 8 | — | 0.8 | 0.002 |
| Ex. 69 | PyC₃SO₃ | SiO₂ + EC* | 180 | 10 | 8 | 90 | 46 | 0.13 |
| Comp. Ex. 48 | PyC₃SO₃ | EC | 180 | 10 | 8 | 95 | 1.6 | 0.003 |

[Metal Oxide except Silica]

| | | | | | | | | |
|---|---|---|---|---|---|---|---|---|
| Ex. 70 | NEt₄Br | Al₂O₃ | 100 | 10 | 1 | 86 | 29 | 0.57 |
| Comp. Ex. 49 | none | Al₂O₃ | 100 | 10 | 1 | — | 0.7 | 0.011 |
| Ex. 71 | NEt₄Br | MgO | 100 | 10 | 1 | 77 | 18 | 0.33 |
| Comp. Ex. 50 | none | MgO | 100 | 10 | 1 | — | 0.1 | 0.001 |
| Ex. 72 | NEt₄Br | ZnO | 100 | 10 | 1 | 79 | 8 | 0.13 |
| Comp. Ex. 51 | none | ZnO | 100 | 10 | 1 | — | 0.1 | 0.001 |
| Ex. 73 | NEt₄Br | SiO₂blue | 100 | 10 | 1 | 98 | 0.8 | 0.013 |
| Comp. Ex. 52 | none | SiO₂blue | 100 | 10 | 1 | — | 0.1 | 0.001 |
| Ex. 74 | NEt₄Br | SiO₂ | 100 | 10 | 1 | 99 | 71 | 2.1 |
| Comp. Ex. 53 | none | SiO₂ | 100 | 10 | 1 | — | 0 | 0 |

[Silica]

| | | | | | | | | |
|---|---|---|---|---|---|---|---|---|
| Comp. Ex. 54 | PyMeCl | SiO₂ | 100 | 10 | 24 | — | 0 | 0 |
| Comp. Ex. 55 | PyMeCl | none | 200 | 25 | 24 | 0.2 | 0.2 | ~0 |

In the Table 3, Me, Et, Bu, Ph, Bz and Py have the same meanings as in Table 1. Im is an imidazolium group substituted with alkyl groups at 1,3-positions. ⁿHp is an n-heptyl group; an ⁿOct is an n-octyl group. ⁿC₁₂, ⁿC₁₈, and so on each are n-C₄H₉, n-C₁₂H₂₅, n-C₁₈H₃₇, and so on. OAc is an acetyl group; and AcO is an acetato ion. C₂OAc is an acetyloxyethyl group. OTs is a tosylate ion, or that is, a p-toluenesulfonate ion; and BF₄ is a tetrafluoroborate ion. PyⁿC₁₆Br is hexadecylpyridinium bromide; TetPh₃I is 2,3,5-triphenyltetrazolium iodide; and PyC₃SO₄ is pyridinium trimethylenesulfone hydroxide inner salt. SiO₂blue is not a compound name, and this means drying silica gel with blue indicator.

The reaction condition (unless otherwise specifically indicated) is as follows:

Propylene oxide; 4 ml

catalyst/propylene oxide=1 mol %

SiO₂ (or other solid additive); 500 mg

### Application to Other Substrate

### Example 75

A cyclic carbonate was produced in the same manner as in Example 13, for which, however, 4 ml of isobutylene oxide was used as the starting material, NEt₄Br was used as the catalyst, and the reaction condition was as follows: Temperature 100° C., reaction time 6 hours. The product was quantitatively analyzed through gas chromatography. The result is shown in Table 4.

### Example 76

A cyclic carbonate was produced in the same manner as in Example 13, for which, however, 4 ml of styrene oxide was used as the starting material, NEt₄Br was used as the catalyst, and the reaction condition was as follows: Temperature 120° C., reaction time 4 hours. The product was quantitatively analyzed through gas chromatography. Since the product was solid, it was dissolved in DMF for analysis. The result is shown in Table 4.

### Example 77

A cyclic carbonate was produced in the same manner as in Example 13, for which, however, 4 ml of cyclohexene oxide was used as the starting material, 0.57 mmol of NEt₄Br and silica were used as the catalyst, and the oxide was reacted at 120° C. for 4 hours. The product was quantitatively analyzed through gas chromatography. The result is shown in Table 4.

### Example 78

A cyclic carbonate was produced nearly in the same manner as in Example 13, for which, however, 5 g of trans-stilbene oxide was used as the starting material, 0.57 mmol of NEt₄Br and 1 g of silica were used as the catalyst, and the oxide was reacted at 100° C. and 25 MPa for 100 hours. Like the styrene oxide, the product was solid. This was quantitatively analyzed through ¹HNMR. The result is shown in Table 4.

### Example 79

A cyclic carbonate was produced in the same manner as in Example 13, for which, however, 500 mg of tetracyanoepoxide was used as the starting material, and this was dissolved in 4 ml of DMF and reacted at 100° C. and 10 MPa for 4 hours in the presence of 0.57 mmol of NEt₄Br as the catalyst. The product was quantitatively analyzed through gas chromatography. The result is shown in Table 4.

TABLE 4

| | | | Reaction | Starting | | Yield |
|---|---|---|---|---|---|---|
| Example | Temp. | Pressure | Time | Material | Product | (Selectivity) |
| Ex. 75 | 100° C. | 10 MPa | 6 h | 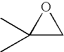 | 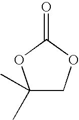 | 95% (96%) |
| Ex. 76 | 120° C. | 10 MPa | 4 h | 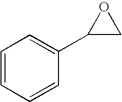 | 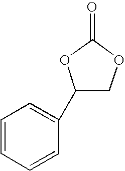 | 95% (100%) |
| Ex. 77 | 120° C. | 10 MPa | 4 h | 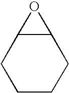 | 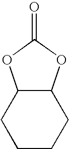 | 65% (70%) |
| Ex. 78 | 100° C. | 25 MPa | 100 h | 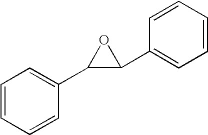 | 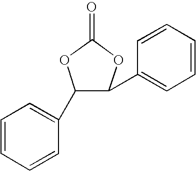 | 60% (100%) |
| Ex. 79 | 100° C. | 10 MPa | 4 h | 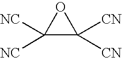 | 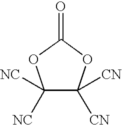 | 30% (90%) |

Reaction Condition: 4 ml or 5 g of the substrate was put into a 20-ml autoclave, and reacted under CO₂ pressure.

As described hereinabove, the catalyst for production of cyclic carbonate from epoxide of the invention has high versatility and its effect is remarkable. In particular, it is effective for 4-substituted epoxide. Many metal oxide solids have a reaction-promoting effect, but silica is most promising for industrial use in that it does not reduce the selectivity and its reaction-promoting effect is great, and that it is inexpensive and is of low toxicity.

1. A catalyst for use in producing a cyclic carbonate from an epoxide and carbon dioxide, which comprises an inorganic solid substance having a surface modified with an ionic substance containing a Group 15 element.

2. The catalyst according to claim 1, wherein the ionic substance containing a Group 15 element is at least one substance selected from an organic phosphonium salt, an organic ammonium salt, an organic arsonium salt and an organic antimonium salt.

3. The catalyst according to claim 2, wherein the salt selected from the organic phosphonium salt, organic ammonium salt, organic arsonium salt and organic antimonium salt is a halide.

4. The catalyst according to claim 3, wherein an anion of the salt selected from the organic phosphonium salt, organic ammonium salt, organic arsonium salt and organic antimonium salt is at least one member selected from a sulfate ion, a hydrogensulfate ion, a phosphate ion, a hydrogenphosphate ion, a dihydrogenphosphate ion, a cyanide ion, an isothiocyanide ion, an isocyanate ion, a carbonate ion and a hydrogencarbonate ion.

5. The catalyst according to any one of claims 1 to 4, wherein the inorganic solid substance is a metal oxide.

6. The catalyst according to claim 5, wherein the metal oxide is a silicon-containing oxide.

7. A catalyst for use in producing a cyclic carbonate from an epoxide and carbon dioxide, which comprises an ionic substance containing a Group 15 element, and an inorganic solid substance.

8. The catalyst according to claim 7, wherein the ionic substance containing a Group 15 element is at least one substance selected from an organic phosphonium salt, an organic ammonium salt, an organic arsonium salt and an organic antimonium salt.

9. The catalyst according to claim 8, wherein the salt selected from the organic phosphonium salt, organic ammonium salt, organic arsonium salt and organic antimonium salt is a halide.

10. The catalyst according to claim 9, wherein an anion of the salt selected from the organic phosphonium salt, organic ammonium salt, organic arsonium salt and organic antimonium salt is at least one member selected from a sulfate ion, a hydrogensulfate ion, a phosphate ion, a hydrogenphosphate ion, a dihydrogenphosphate ion, a cyanide ion, an isothiocyanide ion, an isocyanate ion, a carbonate ion and a hydrogencarbonate ion.

11. The catalyst according to any of claims 7 to 10, wherein the inorganic solid substance is a metal oxide.

12. The catalyst according to claim 11, wherein the metal oxide is a silicon-containing oxide.
